(19) United States
(12) Patent Application Publication
(10) Pub. No.: US 2026/0004764 A1
(43) Pub. Date: Jan. 1, 2026

(54) SYSTEMS AND METHODS FOR DYNAMIC REFERENCE SIGNAL SELECTION AND GAIN ADJUSTMENT IN ADAPTIVE NOISE CANCELLATION SYSTEMS

(71) Applicant: Harman Becker Automotive Systems GmbH, Karlsbad-Ittersbach (DE)

(72) Inventors: Jeffrey Charles Tackett, Allen Park, MI (US); Dylan Michael Stafford, Durham, NC (US); Michael Hinz, North Vancouver (CA)

(21) Appl. No.: 19/190,373

(22) Filed: Apr. 25, 2025

Related U.S. Application Data
(60) Provisional application No. 63/665,147, filed on Jun. 27, 2024.

(51) Int. Cl. G10K 11/178

(52) U.S. Cl. CPC G10K 11/17823; G10K 11/17825; G10K 11/17883; G10K 2210/12821; G10K 2210/30231; G10K 2210/3026; G10K 2210/3027; G10K 2210/3028; G10K 2210/3056; G10K 2210/501

(57) ABSTRACT

Systems and methods are provided for enhancing the performance and adaptability of active noise cancellation (ANC) systems in vehicles by dynamically adjusting reference signal gains and combining reference signals based on vehicle operating conditions. A plurality of noise reference signals are acquired from sources like accelerometers, acoustic vehicle alerting system (AVAS) speakers, LiDAR sensors, seat motors, and HVAC blowers. Vehicle parameters such as speed, seat position, and blower speed are estimated to retrieve dynamic gain values from lookup tables. The dynamic gains are applied to the respective noise reference signals to generate gain-adjusted reference signals. The gain-adjusted signals are mixed using configurable mixing gains to produce a reduced set of combined reference signals provided to an adaptive filter. This approach enables the ANC system to effectively cancel a wider variety of noise sources, including transient sources, while preventing noise boosting artifacts when sources turn off.

### CROSS REFERENCE TO RELATED APPLICATIONS

The present application claims priority to U.S. Provisional Application No. 63/665,147, entitled “SYSTEMS AND METHODS FOR DYNAMIC REFERENCE SIGNAL SELECTION AND GAIN ADJUSTMENT IN ADAPTIVE NOISE CANCELLATION SYSTEMS”, and filed on Jun. 27, 2024. The entire contents of the above-listed application are hereby incorporated by reference for all purposes.

### TECHNICAL FIELD

The present disclosure relates to the field of active noise cancellation (ANC) systems. More specifically, the disclosure pertains to techniques for enhancing the performance and adaptability of ANC systems by dynamically selecting and adjusting reference signals based on vehicle operating conditions.

### BACKGROUND

Active noise cancellation (ANC) systems are widely used in automotive applications to reduce undesirable noise within a vehicle cabin. These systems employ an adaptive filter that generates an anti-noise signal to destructively interfere with and cancel the undesirable noise. The adaptive filter relies on reference signals that are correlated with the noise to be cancelled. Traditionally, these reference signals come from sensors like accelerometers mounted on the vehicle chassis to measure road noise and vibrations.

A key limitation of existing ANC systems is that they can only effectively cancel noise sources that are correlated with the available reference signals. As new types of noise sources are introduced in vehicles, like sounds from components such as pedestrian alert speakers, light detection and ranging (LiDAR) sensors, seat motors, and heating ventilation and air conditioning (HVAC) blowers, the ANC system's noise cancellation performance suffers if it lacks appropriate reference signals for these sources. Simply adding more reference inputs to accommodate every potential noise source is not a viable solution, as it would quickly exceed the computational resources and memory limitations of embedded automotive processors running the ANC algorithms.

Another issue arises when noise sources are transient or non-stationary, such as pedestrian alert speakers that are required to turn on and off based on vehicle speed. When such a noise source abruptly turns off, the adaptive filter can take several seconds to adapt, during which time it continues generating an anti-noise signal that is now mismatched with the current noise environment. This mismatch results in an audible artifact where the ANC system itself generates noise rather than cancelling it, degrading the user experience.

Existing ANC systems lack the flexibility to dynamically adapt reference signal inputs and characteristics to account for the increasing variety of noise sources in modern vehicles, including transient sources that turn on and off. A solution that can effectively cancel a wider range of noise sources without excessive computational overhead is required to provide desired noise cancellation performance in automotive environments.

### SUMMARY

In one aspect, the disclosure provides a method for adjusting reference signals in an ANC system. The method comprises receiving a plurality of noise reference signals, wherein the plurality of noise reference signals comprises signals from one or more accelerometers and one or more additional noise sources. The method estimates one or more vehicle operating parameters and retrieves, from one or more lookup tables, dynamic gain values for each of the plurality of noise reference signals based on the estimated one or more vehicle operating parameters. The retrieved dynamic gain values are applied to the plurality of noise reference signals to generate a plurality of gain-adjusted noise reference signals. The plurality of gain-adjusted noise reference signals are combined to generate a reduced set of combined reference signals. The filter coefficients of the ANC system are then adjusted based on the reduced set of combined reference signals.

In a second aspect, the disclosure provides a noise cancellation system for a vehicle. The system comprises a plurality of reference sensors configured to acquire a plurality of reference signals correlated to noise sources within a vehicle cabin, wherein the noise sources comprise at least one of an acoustic vehicle alerting system (AVAS) speaker, a LIDAR sensor, a seat motor, and an HVAC blower motor. The system includes an adaptive weight filter, a plurality of speakers, a plurality of error microphones, and a signal processing unit. The signal processing unit comprises a non-transitory memory storing a plurality of gain lookup tables and instructions, and a processor. When executing the instructions, the processor estimates one or more vehicle operating parameters, retrieves from the plurality of gain lookup tables a plurality of dynamic gain values for the plurality of reference signals based on the estimated operating parameters and the type of each reference signal, applies the plurality of dynamic gain values to the plurality of reference signals to produce a plurality of gain-adjusted reference signals, combines the plurality of gain-adjusted reference signals into a reduced set of combined reference signals using a reference signal mixer, and provides the reduced set of combined reference signals to the adaptive weight filter to adjust the noise cancellation signal based on the combined reference signals.

In a third aspect, the disclosure further provides a method for adjusting reference signals in an ANC system for a vehicle. The method comprises acquiring a first noise reference signal from an accelerometer and a second noise reference signal from an additional noise source within the vehicle, estimating one or more vehicle operating parameters based on data from one or more vehicle system sensors, retrieving from a first gain lookup table a first dynamic gain value for the first noise reference signal based on the estimated operating parameters, and retrieving from a second gain lookup table a second dynamic gain value for the second noise reference signal based on the estimated operating parameters and the type of the additional noise source. The first dynamic gain value is applied to the first noise reference signal and the second dynamic gain value is applied to the second noise reference signal to generate a first gain-adjusted noise reference signal and a second gain-adjusted noise reference signal, respectively. A first mixing gain is applied to the first gain-adjusted noise reference signal and a second mixing gain is applied to the second gain-adjusted noise reference signal to produce a first mixing gain-adjusted noise reference signal and a second mixing gain-adjusted noise reference signal. The first mixing gain-adjusted noise reference signal and the second mixing gain-adjusted noise reference signal are summed to generate a combined reference signal. The combined reference signal is provided to an adaptive weight filter of the ANC system, and the filter coefficients of the adaptive weight filter are adjusted based on the combined reference signal and a residual signal from a plurality of error microphones within a cabin of the vehicle.

The above systems and methods at least partially address the inability of current ANC systems to effectively cancel noise sources that lack correlated reference signals. By dynamically adjusting reference signal gains based on vehicle operating parameters and mixing additional reference signals into the existing accelerometer reference signals, the disclosed ANC system can adapt to cancel a wider variety of noise sources, including transient sources like pedestrian alert speakers and LiDAR sensors. This overcomes the constraint of having a fixed, limited number of reference inputs in conventional ANC systems.

The above aspects of the disclosure also address the issue of noise boosting artifacts that may occur when a transient noise source abruptly turns off. Conventional ANC systems may take several seconds to adapt when such a noise source disappears, during which time the system generates mismatched anti-noise that is audible as an undesirable artifact. The disclosed dynamic gain adjustment techniques can ramp down or mute reference signal gains for noise sources that turn off, preventing this noise boosting effect. Overall, the disclosed embodiments provide a flexible and computationally efficient solution for improving noise cancellation performance across an increasing variety of noise sources in modern vehicles.

The above advantages and other advantages, and features of the present disclosure will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram illustrating an embodiment of an active noise cancellation (ANC) system for a vehicle;

FIG. 2 is a block diagram depicting an embodiment of a filtered-x least mean squares (FxLMS) adaptive filtering process used in the ANC system of FIG. 1;

FIG. 3 is a block diagram illustrating an embodiment of a modified filtered-x least mean squares (MFxLMS) noise cancellation process used in the ANC system;

FIG. 4 is a flowchart of an embodiment of a method for adjusting reference signals in the ANC system based on vehicle operating parameters;

FIG. 5 is a flowchart illustrating an embodiment of a method for retrieving dynamic gain values from gain lookup tables based on vehicle operating parameters;

FIG. 6 is a flowchart depicting an embodiment of a method for mixing a plurality of gain-adjusted reference signals;

FIG. 7 is a graph illustrating an example of dynamic gain adjustment for an AVAS reference signal based on vehicle speed;

FIG. 8 is a graph showing an example of dynamic gain adjustment for a seat motor reference signal based on seat position;

FIG. 9 is a graph depicting an example of dynamic gain adjustment for an HVAC blower reference signal based on blower speed; and

FIG. 10 is a block diagram illustrating an embodiment of a system for dynamic reference signal selection and gain adjustment in the ANC system.

### DETAILED DESCRIPTION

The present disclosure provides systems and methods for enhancing the performance and adaptability of active noise cancellation (ANC) systems in automotive applications. ANC systems are widely employed in vehicles to reduce undesirable noise within the cabin, thereby improving the acoustic experience for occupants. These systems rely on an adaptive filter that generates an anti-noise signal to destructively interfere with and cancel the undesirable noise. The adaptive filter utilizes reference signals that are correlated with the noise to be cancelled, traditionally obtained from sensors like accelerometers mounted on the vehicle chassis to measure road noise and vibrations.

One limitation of existing ANC systems is their inability to effectively cancel noise sources that lack correlated reference signals. As new types of noise sources are introduced in modern vehicles, such as sounds from pedestrian alert speakers, light detection and ranging (LIDAR) sensors, seat motors, and heating, ventilation, and air conditioning (HVAC) blowers, the noise cancellation performance of conventional ANC systems suffers. Simply adding more reference inputs to accommodate every potential noise source is not a viable solution, as it would quickly exceed the computational resources and memory limitations of the embedded automotive processors running the ANC algorithms.

Another issue arises when noise sources are transient or non-stationary, such as pedestrian alert speakers that are required to turn on and off based on vehicle speed. When such a noise source abruptly turns off, the adaptive filter can take several seconds to adapt, during which time it continues generating an anti-noise signal that is now mismatched with the current noise environment. This mismatch results in an audible artifact where the ANC system itself generates noise rather than cancelling it, degrading the user experience.

The current disclosure addresses these limitations by providing techniques for dynamically adjusting reference signal inputs and characteristics to account for the increasing variety of noise sources in modern vehicles, including transient sources that turn on and off. In one embodiment, the disclosure introduces a method for adjusting reference signals in an ANC system. The method involves receiving a plurality of noise reference signals, including signals from traditional accelerometers as well as additional noise sources like AVAS speakers, LiDAR sensors, seat motors, and HVAC blowers.

The method estimates one or more vehicle operating parameters, such as speed, engine RPM, seat position, or blower speed, and retrieves dynamic gain values for each of the noise reference signals from one or more lookup tables based on the estimated operating parameters. These dynamic gain values are applied to the respective noise reference signals to generate a plurality of gain-adjusted noise reference signals. The gain-adjusted noise reference signals are then combined using a reference signal mixer to generate a reduced set of combined reference signals. This mixing process involves applying respective mixing gains to each gain-adjusted noise reference signal and summing them together. The mixing strategy, including the specific mixing gains applied, can be tuned based on factors like the proximity of the noise source to different accelerometer locations within the vehicle. This mixing strategy enables the use of a variable number of noise reference signals, allowing the system to adapt to different noise sources while operating within the hardware constraints of a vehicle environment, where computational resources and memory are limited.

The reduced set of combined reference signals is then provided to the adaptive weight filter of the ANC system, allowing the filter coefficients to be adjusted based on these combined reference signals. This approach enables the ANC system to effectively cancel a wider variety of noise sources, including transient sources, without excessively increasing computational overhead or memory requirements. Furthermore, the dynamic gain adjustment techniques employed in the current disclosure address the issue of noise boosting artifacts that occur when a transient noise source abruptly turns off. By ramping down or muting the dynamic gain values for reference signals corresponding to noise sources that turn off, the system prevents the adaptive filter from generating mismatched anti-noise signals during the adaptation period, thereby avoiding the undesirable noise boosting effect.

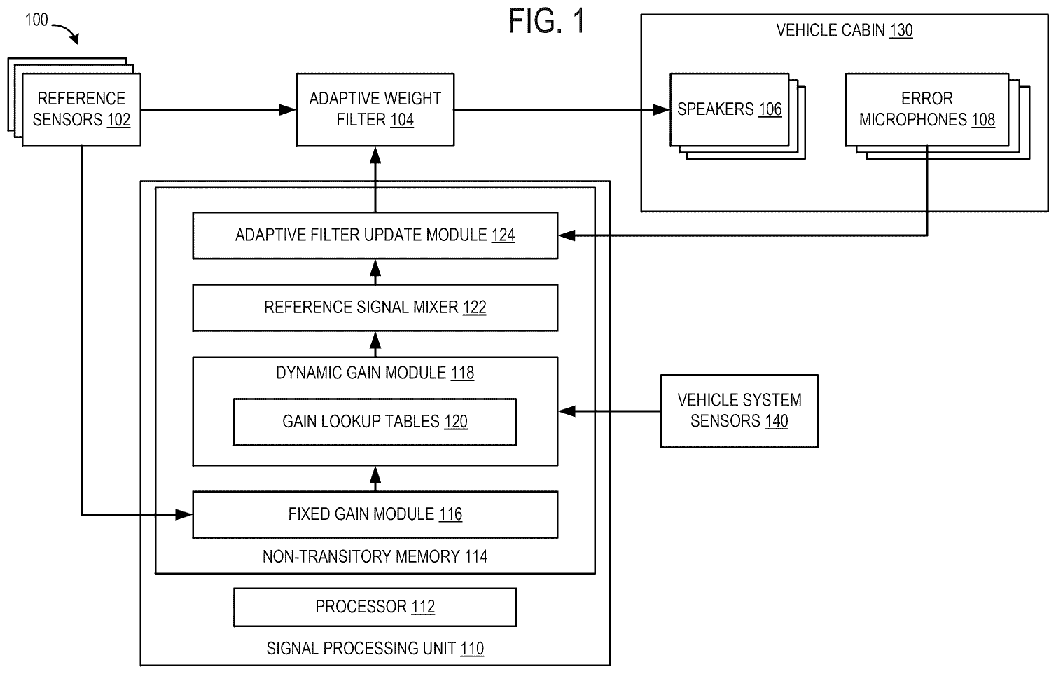

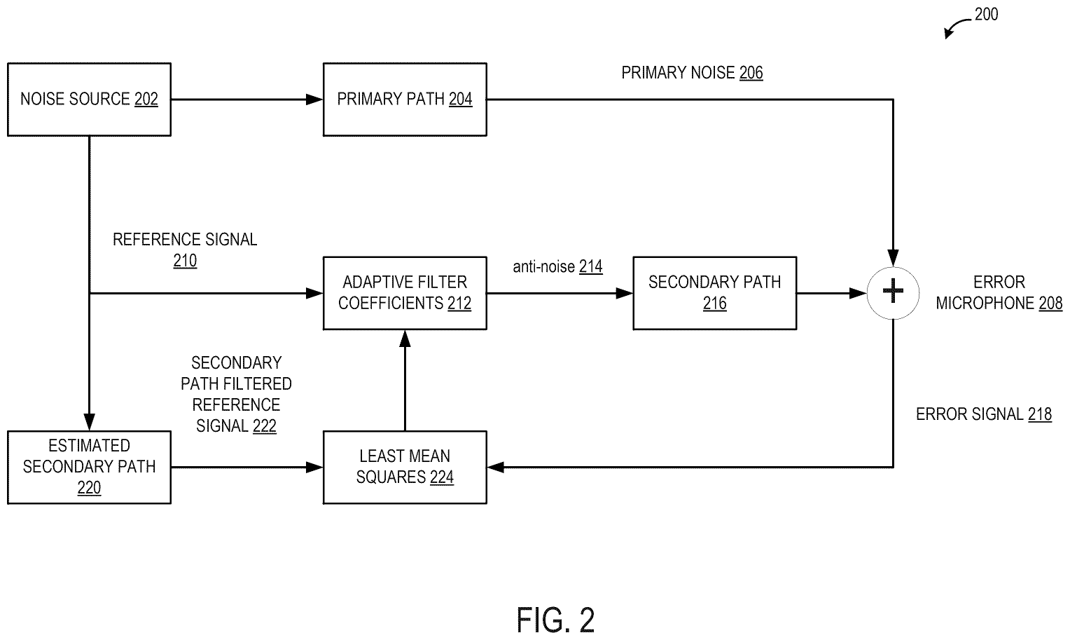

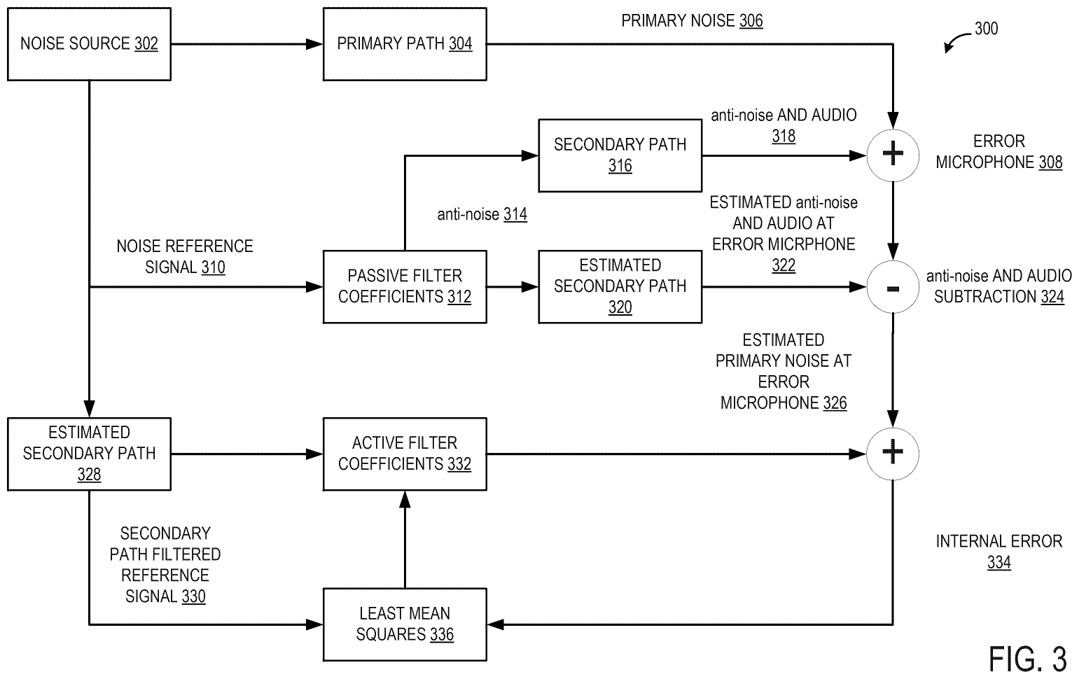

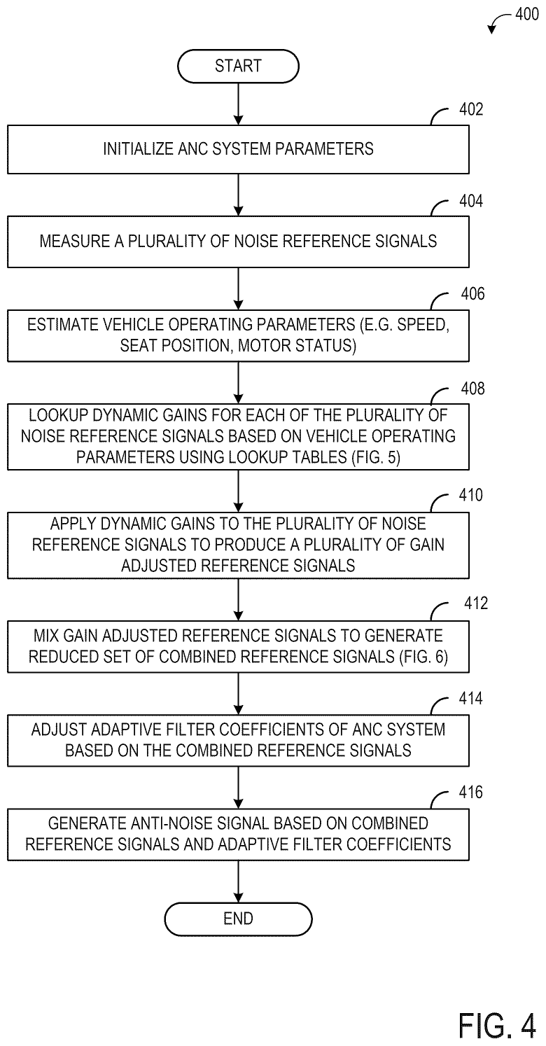

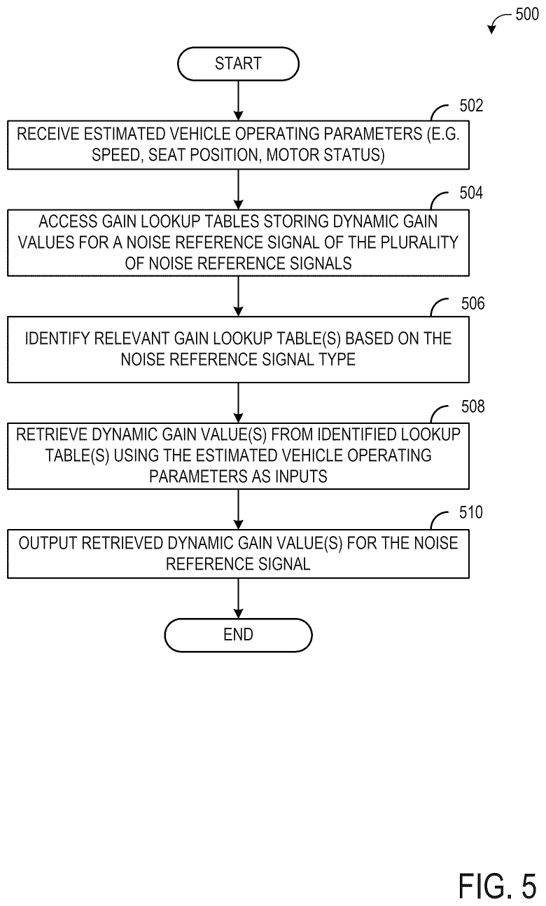

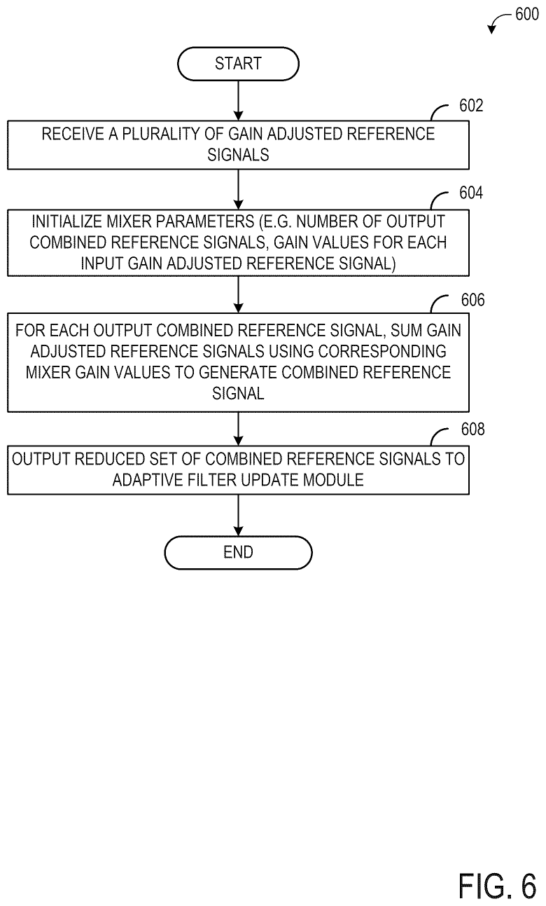

In one embodiment, an ANC system for a vehicle, such as the ANC system 100 depicted in FIG. 1, employs adaptive filtering techniques, such as the filtered-x least mean squares (FxLMS) process illustrated in FIG. 2 and the modified filtered-x least mean squares (MFxLMS) process shown in FIG. 3, to generate an anti-noise signal that cancels undesirable noise within a vehicle cabin. The ANC 100 system utilizes a method for adjusting reference signals based on vehicle operating parameters, as outlined in the flowchart of FIG. 4. This method involves retrieving dynamic gain values from gain lookup tables (as detailed in FIG. 5) based on estimated vehicle parameters, applying the dynamic gains to the reference signals to generate gain-adjusted reference signals, and combining the gain-adjusted reference signals into a reduced set of combined reference signals using a mixing process (as detailed in FIG. 6).

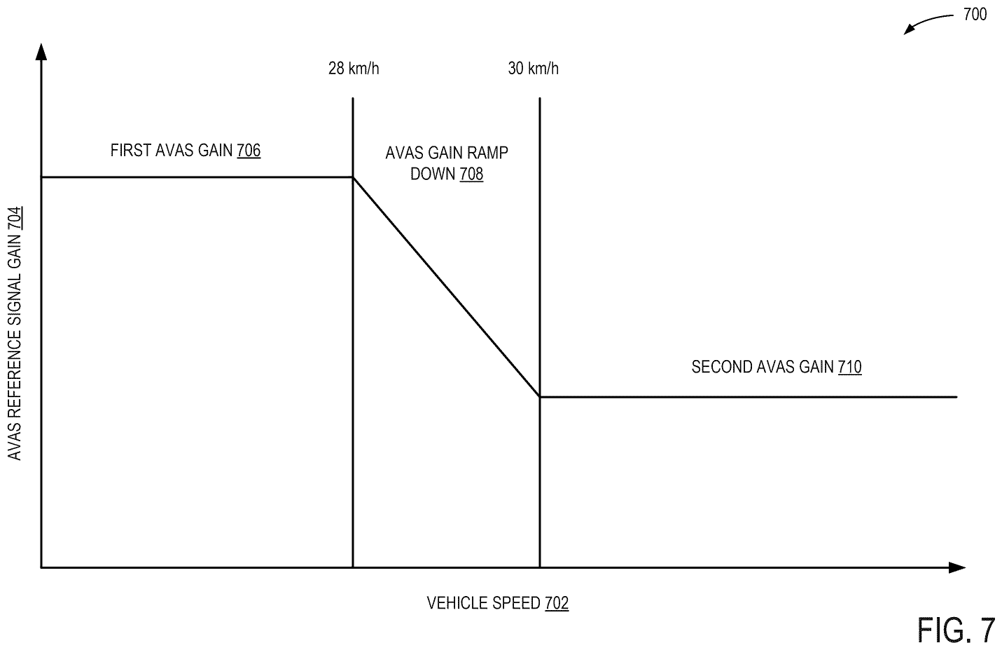

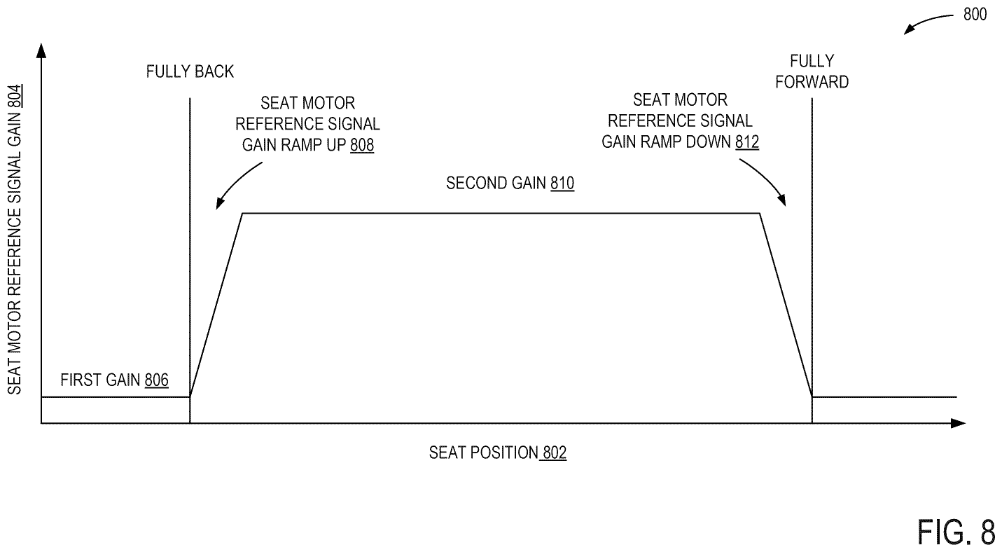

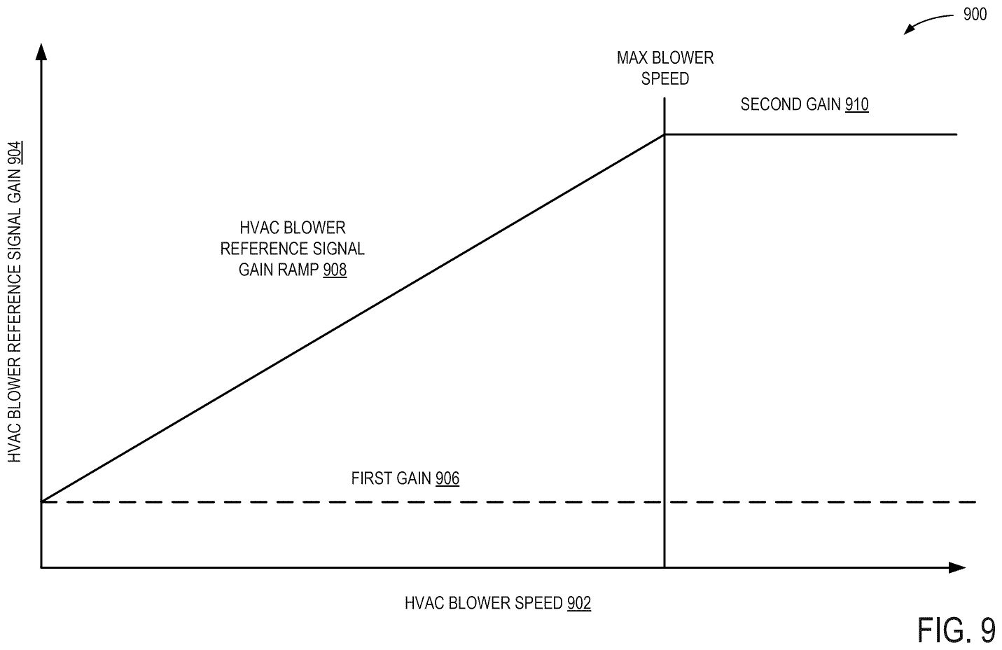

The dynamic gain adjustment process enables the ANC system to adapt to various noise sources and vehicle conditions. For instance, FIG. 7 illustrates an example of dynamically adjusting the gain of an Acoustic Vehicle Alerting System (AVAS) reference signal based on vehicle speed, while FIG. 8 shows an example of adjusting the gain of a seat motor reference signal based on seat position. Similarly, FIG. 9 depicts an example of adjusting the gain of an HVAC blower reference signal based on the blower speed. These dynamic gain adjustments allow the ANC system to effectively cancel noise sources that may appear or disappear under certain vehicle operating conditions, preventing noise boosting artifacts that can occur when a noise source abruptly turns off.

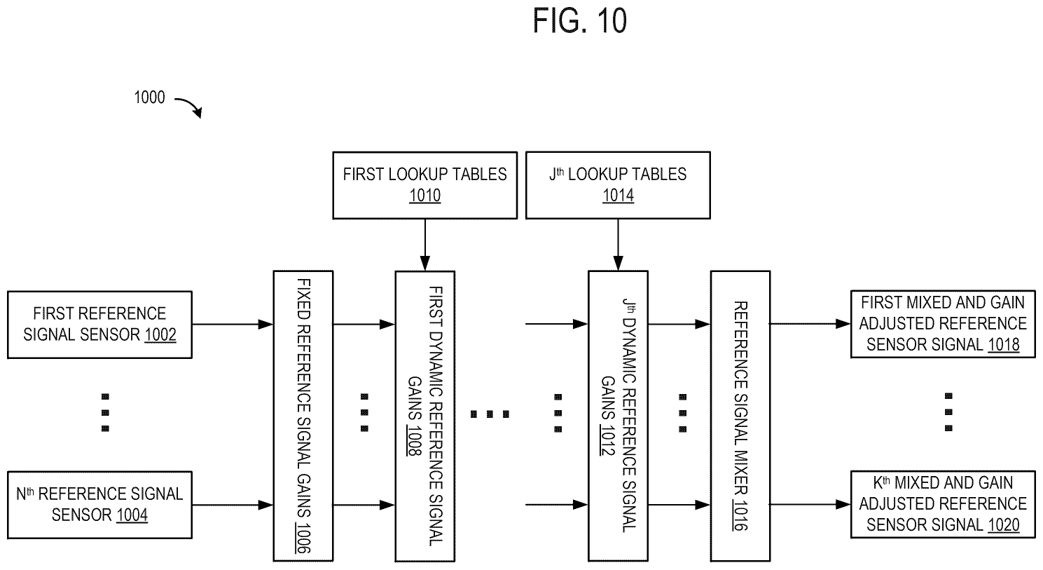

Further, FIG. 10 illustrates an embodiment of a system for dynamic reference signal selection and gain adjustment in the ANC system. The system comprises various components, such as lookup tables for storing dynamic gain values, a reference signal mixer for combining gain-adjusted reference signals, and a signal processing unit that executes the necessary operations for estimating vehicle parameters, retrieving dynamic gains, applying gains to reference signals, and adjusting the adaptive filter coefficients based on the combined reference signals.

Referring to FIG. 1, ANC system 100 designed for use within a vehicle cabin 130 is shown. The ANC system 100 is configured to actively reduce unwanted noise within the vehicle cabin 130 by generating an anti-noise signal that destructively interferes with the undesirable noise.

The ANC system 100 comprises a plurality of reference sensors 102, which are responsible for acquiring reference signals correlated with the sources of noise present within the vehicle cabin 130. These reference sensors 102 can take various forms, such as accelerometers mounted on the vehicle chassis to detect road noise and vibrations, microphones positioned near known noise sources like AVAS speakers or motors, or current sensors coupled to noise-generating components like seat motors or HVAC blowers. In one embodiment, the reference sensors 102 include a combination of accelerometers and current sensors coupled to noise-generating components like seat motors or HVAC blower motors. These current sensors can provide reference signals that are directly correlated with the noise generated by these components, allowing the ANC system 100 to more accurately target and cancel these specific noise sources.

The reference signals acquired by the reference sensors 102 are fed into an adaptive weight filter 104, which applies an adaptive filtering algorithm, such as the filtered-x least mean squares (FxLMS) or modified filtered-x least mean squares (MFxLMS) algorithm, to the reference signals. The adaptive weight filter 104 generates an anti-noise signal that is designed to destructively interfere with and cancel the undesirable noise within the vehicle cabin 130. In one embodiment, the adaptive weight filter 104 employs the FxLMS algorithm, which is effective for canceling broadband noise sources like road noise. The FxLMS algorithm adapts the filter coefficients of the adaptive weight filter 104 based on the reference signals and the residual noise captured by error microphones 108 within the vehicle cabin 130. In another embodiment, the adaptive weight filter 104 utilizes the MFxLMS algorithm, which is particularly suitable for canceling narrowband noise sources like engine harmonics or tonal noise from components like HVAC blowers or LiDAR sensors. The MFxLMS algorithm incorporates additional filtering stages to target specific frequency bands and adapt the filter coefficients accordingly.

The anti-noise signal generated by the adaptive weight filter 104 is fed to a plurality of speakers 106 strategically positioned within the vehicle cabin 130. These speakers 106 emit the anti-noise signal into the cabin space, creating an acoustic field that destructively interferes with and cancels the undesirable noise. In one embodiment, the speakers 106 are distributed throughout the vehicle cabin 130, with speakers placed near the expected locations of noise sources, such as near the vehicle's suspension components for road noise cancellation or near the HVAC vents for canceling blower noise. This strategic placement of speakers 106 ensures that the anti-noise signal is effectively targeted towards the specific noise sources within the cabin. In another embodiment, the speakers 106 may be integrated into the vehicle's existing audio system, leveraging the existing speaker locations and configurations. This approach can reduce the need for additional speakers and simplify the installation of the ANC system 100 within the vehicle cabin 130.

To monitor the effectiveness of the noise cancellation process, the ANC system 100 includes a plurality of error microphones 108 positioned within the vehicle cabin 130. These error microphones 108 capture the residual signal, which is the resultant sound after the interaction of the emitted anti-noise signal with the original noise sources within the cabin. In one embodiment, the error microphones 108 are strategically placed near the expected locations of occupants' ears or heads, ensuring that the residual signal accurately represents the noise experienced by the vehicle's passengers. This placement allows the ANC system 100 to optimize the noise cancellation performance for the occupants' listening positions. In another embodiment, the error microphones 108 may be distributed throughout the vehicle cabin 130, providing a more comprehensive representation of the residual noise field. This approach can be beneficial in situations where the noise sources or occupant positions are variable or unpredictable, allowing the ANC system 100 to adapt to a wider range of noise conditions and occupant configurations.

The ANC system 100 includes a signal processing unit 110, which serves as the computational core of the system. The signal processing unit 110 comprises a processor 112 and a non-transitory memory 114, which together execute machine-readable instructions and algorithms for noise cancellation within the vehicle cabin 130.

The processor 112 is a hardware component designed to execute machine-executable instructions stored in the non-transitory memory 114. These instructions include computational tasks for real-time signal processing, such as adaptive filtering algorithms, dynamic gain adjustments of the reference noise signals, dynamic mixing of the various noise reference sensor signals from the plurality of reference sensors 102, and gradient calculations for filter weight updates. The processor 112 processes the reference signals from the reference sensors 102 and the residual signals from the error microphones 108 to generate the anti-noise signal in real-time, ensuring effective noise cancellation within the vehicle cabin 130.

The non-transitory memory 114 stores the machine-readable instructions and data required for the operation of the ANC system 100. It maintains this information even when the system is powered off, ensuring that the necessary firmware, software, and data structures are readily available for the processor 112. The non-transitory memory 114 may consist of various non-volatile storage technologies, such as read-only memory (ROM), flash memory, or other persistent storage media.

Within the non-transitory memory 114, several modules are implemented to enhance the performance and adaptability of the ANC system 100. One such module is the fixed gain module 116, which receives and adjusts the gain of the reference signals from the reference sensors 102. The fixed gain module 116 applies predetermined gain values to the reference signals, ensuring that the signals are properly scaled and balanced before further processing. In one embodiment, the fixed gain module 116 applies gain values that are determined during a calibration process, where the relative strengths of the reference signals are measured, and appropriate gain factors are calculated to equalize their contributions. This calibration process can be performed during the installation or setup of the ANC system 100 within the vehicle cabin 130. In another embodiment, the fixed gain module 116 may apply gain values that are dynamically adjusted based on feedback from the error microphones 108 or other sensors within the vehicle cabin 130. This dynamic adjustment can help compensate for changes in the noise environment or variations in the reference signal strengths, ensuring that the ANC system 100 maintains optimal performance under varying conditions.

The output of the fixed gain module 116 is fed into the dynamic gain module 118, which is responsible for applying dynamic gain adjustments to the reference signals based on various vehicle operating conditions. The dynamic gain module 118 utilizes gain lookup tables 120, which are stored within or coupled to the dynamic gain module 118. In one embodiment, the gain lookup tables 120 store pre-calculated gain values that are indexed by various vehicle operating parameters, such as vehicle speed, seat position, motor status, or HVAC blower speed. Gain lookup tables 120 allow the dynamic gain module 118 to retrieve and apply appropriate gain values to the reference signals based on the current operating conditions of the vehicle.

For example, the gain lookup tables 120 may include a table that adjusts the gain of a reference signal from an AVAS speaker based on the vehicle's speed. As the vehicle accelerates beyond a certain speed threshold, the AVAS speaker may be required to turn off, and the corresponding gain value in the lookup table can be used to ramp down or mute the AVAS reference signal, preventing the ANC system 100 from boosting anti-noise for a non-existent source. In another embodiment, the gain lookup tables 120 may include multiple tables for different types of reference signals, each tailored to the specific characteristics and operating conditions of the corresponding noise source. For instance, one table may adjust the gain of a seat motor reference signal based on the seat position, while another table adjusts the gain of an HVAC blower reference signal based on the blower speed.

The dynamic gain module 118 retrieves the appropriate gain values from the gain lookup tables 120 based on the estimated vehicle operating parameters, which can be obtained from various vehicle system sensors 140. The vehicle system sensors 140 may include speed sensors, seat position sensors, motor status sensors, or HVAC system sensors, among others.

The gain-adjusted reference signals from the dynamic gain module 118 are then fed into the reference signal mixer 122. The reference signal mixer 122 is responsible for combining or mixing the gain-adjusted reference signals into a reduced set of combined reference signals. In one embodiment, the reference signal mixer 122 applies a predetermined mixing strategy to combine the gain-adjusted reference signals. This mixing strategy may involve summing the reference signals with specific mixing gain values or applying a weighted combination based on factors such as the proximity of the reference sensors 102 to the noise sources or the relative importance of each noise source.

For example, the reference signal mixer 122 may combine a gain-adjusted reference signal from an accelerometer mounted near the front suspension with a gain-adjusted reference signal from an AVAS speaker located in the front of the vehicle. The mixing strategy could involve applying a higher mixing gain to the AVAS reference signal if the AVAS noise is more prominent or applying a lower mixing gain if the road noise from the front suspension is the dominant source. In another embodiment, the reference signal mixer 122 may employ an adaptive mixing strategy, where the mixing gains or combinations are dynamically adjusted based on feedback from the error microphones 108 or other sensors within the vehicle cabin 130. This adaptive approach allows the ANC system 100 to optimize the contribution of each reference signal to the combined reference signals, ensuring effective noise cancellation under varying noise conditions.

The reduced set of combined reference signals from the reference signal mixer 122 is then fed into the adaptive filter update module 124. This module 124 employs the ANC algorithm, such as the FxLMS or MFxLMS algorithm, to adjust the coefficients of the adaptive weight filter 104 based on the combined reference signals and the residual signals from the error microphones 108. In one embodiment, the adaptive filter update module 124 implements the FxLMS algorithm, which is suitable for canceling broadband noise sources like road noise. The FxLMS algorithm adapts the filter coefficients of the adaptive weight filter 104 by minimizing the residual signal captured by the error microphones 108, effectively canceling the undesirable noise within the vehicle cabin 130. In another embodiment, the adaptive filter update module 124 may utilize the MFxLMS algorithm, which is particularly effective for canceling narrowband noise sources like engine harmonics or tonal noise from components like HVAC blowers or LiDAR sensors. The MFxLMS algorithm incorporates additional filtering stages to target specific frequency bands and adapt the filter coefficients accordingly, providing enhanced noise cancellation performance for these types of noise sources.

The adaptive filter update module 124 continuously updates the filter coefficients of the adaptive weight filter 104 based on the combined reference signals and the residual signals from the error microphones 108. This adaptive process ensures that the ANC system 100 can effectively cancel a wide range of noise sources within the vehicle cabin 130, including both broadband and narrowband noise, while dynamically adjusting to changes in the noise environment or vehicle operating conditions.

Overall, the ANC system 100 leverages a combination of reference sensors 102, adaptive filtering techniques, dynamic gain adjustment, and reference signal mixing to provide effective noise cancellation within the vehicle cabin 130. By dynamically adapting to various noise sources and vehicle operating conditions, the ANC system 100 enhances the acoustic comfort and experience for the vehicle's occupants, reducing the impact of unwanted noise and creating a more pleasant cabin environment.

Referring to FIG. 2, a block diagram of the filtered-x least mean square (FxLMS) process 200 for noise cancellation is shown. The FxLMS process 200 may be employed by ANC system 100 for reducing noise in a vehicle of cabin.

The noise source 202 represents the source of the primary noise 206 that needs to be canceled. In an automotive context, the noise source 202 can originate from various sources, such as the engine, road interactions, or aerodynamic turbulence. The primary noise 206 propagates through the primary path 204, which represents the acoustic transfer function from the noise source 202 to the error microphone 208 positioned within the vehicle cabin.

The error microphone 208 captures the residual noise, referred to as the error signal 218, after the interaction between the primary noise 206 and the anti-noise 214 generated by the ANC system. The error signal 218 is equal to the sum of the primary noise 206 and the anti-noise 214 after traversing the secondary path 216, which represents the acoustic transfer function from the speakers emitting the anti-noise 214 to the error microphone 208.

The reference signal 210 is acquired by a reference sensor, such as an accelerometer or a microphone, and is correlated with the primary noise 206 emitted by the noise source 202. In one embodiment, the reference sensor can be an accelerometer mounted on the vehicle's suspension system, detecting vibrations associated with road noise. Alternatively, the reference sensor can be a microphone positioned near the engine compartment, capturing engine noise as the reference signal 210.

The adaptive filter coefficients 212 are the adjustable parameters of an adaptive filter algorithm, such as the FxLMS, which generates the anti-noise 214. The adaptive filter coefficients 212 are continuously updated based on the error signal 218 and the secondary path filtered reference signal 222, with the goal of minimizing the residual noise captured by the error microphone 208.

The anti-noise 214 is the cancellation signal generated by the adaptive filter algorithm using the adaptive filter coefficients 212 and the reference signal 210. The anti-noise 214 is emitted through speakers within the vehicle cabin and is designed to destructively interfere with the primary noise 206, effectively canceling it out. The emitted anti-noise 214 traverses the secondary path 216 before reaching the error microphone 208. The secondary path 216 is the actual acoustic transfer function from the speakers emitting the anti-noise 214 to the error microphone 208. It represents the true response of the vehicle cabin's acoustic environment, including factors such as cabin geometry, upholstery materials, and the presence of passengers or cargo.

The estimated secondary path 220 is a digital filter that approximates the secondary path 216. The accuracy of the estimated secondary path 220 is enables the effective operation of the FxLMS process 200, as it is used to filter the reference signal 210, producing the secondary path filtered reference signal 222.

The secondary path filtered reference signal 222 is obtained by convolving the reference signal 210 with the estimated secondary path 220. This filtering operation accounts for the acoustic effects of the secondary path 216 on the anti-noise 214, ensuring that the adaptive filter coefficients 212 are updated based on the reference signal 210 as perceived by the error microphone 208.

The least mean squares (LMS) 224 module is responsible for updating the adaptive filter coefficients 212 based on the error signal 218 and the secondary path filtered reference signal 222. The LMS algorithm is an adaptive filtering technique that iteratively adjusts the filter coefficients 212 to minimize the mean squared error, which in this case is the error signal 218. In one embodiment, the LMS 224 module can implement the normalized least mean squares (NL M S) algorithm, which adjusts the step size of the coefficient updates based on the power of the secondary path filtered reference signal 222, improving convergence and stability. Alternatively, the LMS 224 module can employ a variable step-size LMS algorithm, where the step size is dynamically adjusted based on the characteristics of the error signal 218 and the secondary path filtered reference signal 222, further enhancing the convergence and tracking performance of the adaptive filter.

The FxLMS process 200 operates in a closed-loop manner, continuously updating the adaptive filter coefficients 212 based on the error signal 218 and the secondary path filtered reference signal 222. As the adaptive filter coefficients 212 converge, the anti-noise 214 generated by the adaptive filter becomes increasingly effective in canceling the primary noise 206, resulting in a reduced error signal 218 and an improved acoustic environment within the vehicle cabin.

Referring to FIG. 3, a diagram of the Modified Filtered-x Least Mean Squares (MFxLMS) process 300 for noise cancellation is shown. The MFxLMS process 300 is designed to actively reduce unwanted noise within an environment, such as a vehicle cabin, by generating an anti-noise signal that destructively interferes with the primary noise source.

The noise source 302 represents the origin of the primary noise 306 to be canceled. In an automotive context, the noise source 302 can originate from various sources, such as the engine, road interactions, or aerodynamic turbulence. The primary noise 306 propagates through the primary path 304, which represents the acoustic transfer function from the noise source 302 to the error microphone 308 positioned within the environment.

The error microphone 308 captures the residual signal after the interaction between the primary noise 306 and the anti-noise signal 314 generated by the MFxLMS process 300. This residual signal is a combination of the remaining primary noise 306 and the anti-noise signal 314 after traversing the secondary path 316, which represents the acoustic transfer function from the speakers emitting the anti-noise signal 314 to the error microphone 308.

The noise reference signal 310 is acquired by a reference sensor, such as an accelerometer or a microphone, and is correlated with the primary noise 306 emitted by the noise source 302. In one embodiment, the reference sensor can be an accelerometer mounted on the vehicle's suspension system, detecting vibrations associated with road noise. Alternatively, the reference sensor can be a microphone positioned near the engine compartment, capturing engine noise as the noise reference signal 310.

The passive filter coefficients 312 are the adjustable parameters of an adaptive filter algorithm, such as the MFxLMS, which generates the anti-noise signal 314. The passive filter coefficients 312 are continuously updated by copying the values from the active filter coefficients 332, which are determined by the LMS 336 module based on the internal error 334 and the secondary path filtered reference signal 330.

The anti-noise signal 314 is the cancellation signal generated by the adaptive filter algorithm using the passive filter coefficients 312 and the noise reference signal 310. The anti-noise signal 314 is emitted through speakers within the environment and is designed to destructively interfere with the primary noise 306, effectively canceling it out. The emitted anti-noise signal 314 traverses the secondary path 316 before reaching the error microphone 308.

The estimated secondary path 320 is a digital filter that approximates the secondary path 316. The accuracy of the estimated secondary path 320 enables the effective operation of the MFxLMS process 300, as it is used to estimate anti-noise and audio 318 at error microphone 322. In one embodiment, the estimated secondary path 320 can be obtained through an offline modeling technique, where a known excitation signal is played through the speakers, and the response is measured at the error microphone 308 to estimate the secondary path transfer function. In another embodiment, the estimated secondary path 320 can be updated online during the operation of the MFxLMS process 300, using adaptive filtering techniques to continuously refine the secondary path estimate.

The anti-noise and audio 318 subtraction 324 subtracts the estimated anti-noise and audio at the error microphone 322 from the residual signal measured by the error microphone 308 to produce the estimated primary noise at the error microphone 326. This operation effectively removes the contribution of the anti-noise signal 314 from the residual signal, allowing the MFxLMS process 300 to focus on minimizing the primary noise 306.

The internal error 334 is produced by adding the estimated primary noise at the error microphone 326 with the anti-noise signal produced by the active filter coefficients 332. This internal error 334 is fed to the least mean squares (LMS) 336 module for updating the active filter coefficients 332. The internal error 334 represents the difference between the estimated primary noise and the anti-noise signal generated by the active filter coefficients 332, providing a measure of the residual noise that needs to be minimized.

The estimated secondary path 328 is another digital filter that approximates the secondary path 316. It is used to filter the noise reference signal 310 to produce the secondary path filtered reference signal 330, which is then fed to the LMS 336 module. The secondary path filtered reference signal 330 accounts for the acoustic effects of the secondary path 316 on the anti-noise signal 314, ensuring that the active filter coefficients 332 are updated based on the reference signal 310 as perceived by the error microphone 308.

The LMS 336 module is responsible for updating the active filter coefficients 332 based on the secondary path filtered reference signal 330 and the internal error 334. The LMS algorithm is an adaptive filtering technique that iteratively adjusts the filter coefficients 332 to minimize the mean squared error, which in this case is the internal error 334. In one embodiment, the L M S 336 module can implement the normalized least mean squares (N LMS) algorithm, which adjusts the step size of the coefficient updates based on the power of the secondary path filtered reference signal 330, improving convergence and stability. Alternatively, the LMS 336 module can employ a variable step-size LMS algorithm, where the step size is dynamically adjusted based on the characteristics of the internal error 334 and the secondary path filtered reference signal 330, further enhancing the convergence and tracking performance of the adaptive filter.

The active filter coefficients 332 are the updated weights determined by the LMS 336 module. These updated weights are then copied to the passive filter coefficients 312, which are used to generate the anti-noise signal 314. This continuous update process ensures that the MFxLMS process 300 can effectively cancel the primary noise 306 by adapting the anti-noise signal 314 to match the changing noise conditions within the environment.

The MFxLMS process 300 operates in a closed-loop manner, continuously updating the active filter coefficients 332 based on the internal error 334 and the secondary path filtered reference signal 330. As the active filter coefficients 332 converge, the anti-noise signal 314 generated by the passive filter coefficients 312 becomes increasingly effective in canceling the primary noise 306, resulting in a reduced residual signal captured by the error microphone 308 and an improved acoustic environment.

Referring now to FIG. 4, a flowchart of a method 400 for adjusting reference signals in an ANC system based on vehicle operating parameters is shown. The method 400 is designed to enhance the performance and adaptability of the ANC system by dynamically selecting and adjusting reference signals based on various vehicle conditions, enabling effective cancellation of a wider range of noise sources within the vehicle cabin.

The method 400 begins with operation 402, where the ANC system parameters are initialized. In one embodiment, this operation involves setting initial values for various parameters and configurations of the ANC system, such as the number of reference sensors, the number of error microphones, the number of speakers, and the initial filter coefficients for the adaptive weight filter. Additionally, operation 402 may include loading pre-calculated lookup tables for dynamic gain values and initializing any necessary data structures or buffers required for the subsequent operations of the method.

At operation 404, a plurality of noise reference signals are measured. These reference signals are acquired from various reference sensors (such as reference sensors 102) positioned within a vehicle cabin or mounted on a vehicle chassis. The reference sensors may include accelerometers configured to detect vibrations associated with road noise, microphones positioned to capture ambient noise outside the vehicle cabin, or non-acoustic sensors configured to detect operational parameters of the vehicle indicative of noise generation, such as current sensors coupled to noise-generating components like seat motors or HVAC blower motors. In one embodiment, the plurality of noise reference signals measured in operation 404 includes signals from traditional accelerometers as well as additional noise sources like AVAS speakers, LiDAR sensors, seat motors, and HVAC blower motors. By incorporating these additional noise sources as reference signals, the ANC system can more effectively target and cancel a wider range of noise sources within the vehicle cabin.

At operation 406, one or more vehicle operating parameters are estimated. These operating parameters may include, but are not limited to, vehicle speed, engine RPM, seat position, motor status (e.g., seat motor, HVAC blower motor), and blower speed. The estimation of these parameters can be performed using data from various vehicle system sensors (such as vehicle system sensors 140), such as speed sensors, seat position sensors, motor status sensors, or HVAC system sensors. In one embodiment, the vehicle operating parameters are obtained through a CAN bus interface, which allows the ANC system to receive real-time data from the vehicle's internal communication network. Alternatively, dedicated sensors or external interfaces may be used to acquire the necessary operating parameter data.

At operation 408, dynamic gain values for each of the plurality of noise reference signals are retrieved from one or more lookup tables based on the estimated vehicle operating parameters. The lookup tables store pre-calculated gain values indexed by various operating parameters and the type of each reference signal. In one embodiment, a dynamic gain module, such as dynamic gain module 118, identifies a specific lookup table corresponding to each noise reference signal based on the type of the reference signal (e.g., accelerometer, AVAS speaker, LiDAR sensor, seat motor, HVAC blower). The dynamic gain module then retrieves the appropriate dynamic gain value from the identified lookup table using the estimated vehicle operating parameters as inputs. For example, if the noise reference signal corresponds to an AVAS speaker, the dynamic gain module may retrieve a dynamic gain value from a lookup table indexed by vehicle speed, as AVAS speakers may turn off above a certain speed threshold. Similarly, if the noise reference signal is from a seat motor, the dynamic gain module may retrieve a dynamic gain value from a lookup table indexed by seat position, as the noise generated by the seat motor may vary depending on the seat's position.

At operation 410, the retrieved dynamic gain values are applied to the plurality of noise reference signals to produce a plurality of gain-adjusted noise reference signals. This operation involves scaling or adjusting the amplitude of each noise reference signal based on the corresponding dynamic gain value retrieved in operation 408. In one embodiment, the dynamic gain module 118 multiplies each noise reference signal by its respective dynamic gain value to generate the gain-adjusted noise reference signals. This adjustment allows the ANC system to dynamically emphasize or de-emphasize specific noise reference signals based on the vehicle's operating conditions, enabling more effective noise cancellation. For example, if the AVAS speaker is commanded to turn off above a certain speed threshold, the dynamic gain module 118 can ramp down or mute the dynamic gain value for the AVAS reference signal as the vehicle approaches and exceeds that speed threshold. This prevents the ANC system from generating mismatched anti-noise signals and avoids the undesirable noise boosting effect that can occur when a transient noise source abruptly turns off.

At operation 412, the gain-adjusted noise reference signals are mixed to generate a reduced set of combined reference signals. This operation involves combining or summing the gain-adjusted noise reference signals using a reference signal mixer, which applies respective mixing gains to each signal before combining them. In one embodiment, the reference signal mixer applies a predetermined mixing strategy to combine the gain-adjusted noise reference signals. This mixing strategy may involve summing the reference signals with specific mixing gain values or applying a weighted combination based on factors such as the proximity of the reference sensors to the noise sources or the relative importance of each noise source. For example, the reference signal mixer may combine a gain-adjusted reference signal from an accelerometer mounted near the front suspension with a gain-adjusted reference signal from an AVAS speaker located in the front of the vehicle. The mixing strategy could involve applying a higher mixing gain to the AVAS reference signal if the AVAS noise is more prominent or applying a lower mixing gain if the road noise from the front suspension is the dominant source.

The mixing strategy employed by the reference signal mixer can be tuned based on factors like the proximity of the noise source to different accelerometer locations within the vehicle. This mixing strategy enables the use of a variable number of noise reference signals, allowing the system to adapt to different noise sources while operating within the hardware constraints of a vehicle environment, where computational resources and memory are limited.

At operation 414, the filter coefficients of the adaptive weight filter of the ANC system are adjusted based on the reduced set of combined reference signals generated in operation 412. The adaptive weight filter employs an adaptive filtering algorithm, such as the FxLMS or MFxLMS algorithm, to generate the anti-noise signal for canceling the undesirable noise within the vehicle cabin. In one embodiment, an adaptive filter update module within the signal processing unit provides the reduced set of combined reference signals to the adaptive weight filter. The adaptive filter update module then adjusts the filter coefficients of the adaptive weight filter based on the combined reference signals and the residual signals from the error microphones, using the FxLMS or MFxLMS algorithm.

At operation 416, an anti-noise signal is generated based on the combined reference signals and the adjusted adaptive filter coefficients of the ANC system. This anti-noise signal is produced to destructively interfere with and cancel the undesirable noise within the vehicle cabin. In one embodiment, the adaptive weight filter generates the anti-noise signal by applying the adjusted filter coefficients to the reduced set of combined reference signals. The anti-noise signal is then fed to the plurality of speakers positioned within the vehicle cabin, which emit the anti-noise signal into the cabin space, creating an acoustic field that destructively interferes with and cancels the undesirable noise.

Following operation 416, the method 400 may end or repeat in a continuous loop, allowing the ANC system to continuously adapt and adjust the reference signals based on the changing vehicle operating conditions and noise environment within the vehicle cabin. The method 400 provides a flexible and computationally efficient approach for enhancing the noise cancellation performance of an ANC system across an increasing variety of noise sources in modern vehicles. By dynamically adjusting reference signal gains based on vehicle operating parameters and mixing additional reference signals into the existing accelerometer reference signals, the ANC system can adapt to cancel a wider range of noise sources, including transient sources like pedestrian alert speakers and LiDAR sensors. This overcomes the constraint of having a fixed, limited number of reference inputs in conventional ANC systems. Furthermore, the dynamic gain adjustment techniques employed in the method 400 address the issue of noise boosting artifacts that may occur when a transient noise source abruptly turns off. By ramping down or muting the dynamic gain values for reference signals corresponding to noise sources that turn off, the method 400 prevents the A N C system from generating mismatched anti-noise signals during the adaptation period, thereby avoiding the undesirable noise boosting effect.

Referring to FIG. 5, a flowchart of a method 500 for dynamically adjusting noise reference signal gain values based on vehicle operating parameters is shown. Method 500 may be employed at operation 408 of method 400 (FIG. 4) to retrieve dynamic gain values from gain lookup tables based on the estimated vehicle operating parameters. The dynamic gain values are subsequently applied to the respective noise reference signals to generate gain-adjusted noise reference signals.

At operation 502, the signal processing unit receives estimated vehicle operating parameters. These parameters may include, but are not limited to, vehicle speed, seat position, motor status (e.g., seat motor, HVAC blower motor), and other operational parameters indicative of potential noise sources within the vehicle cabin. In one embodiment, the vehicle operating parameters are obtained from various vehicle system sensors, such as speed sensors, seat position sensors, motor current sensors, or tachometers. Alternatively, the vehicle operating parameters may be acquired through a CAN bus interface, which receives data from the vehicle's electronic control units (ECUs) and subsystems.

At operation 504, the signal processing unit accesses gain lookup tables stored in a non-transitory memory of the ANC system. These gain lookup tables contain pre-calculated dynamic gain values that are indexed by the vehicle operating parameters. The dynamic gain values are used to adjust the gains of the noise reference signals based on the current operating conditions of the vehicle. In one embodiment, the gain lookup tables are populated during a calibration or tuning process, where the dynamic gain values are determined through testing and empirical calibration to achieve the desired noise cancellation performance for various noise sources and vehicle conditions. For example, the gain lookup tables may be generated by driving the vehicle under different operating conditions (e.g., varying speeds, seat positions, motor states) and measuring the noise levels within the cabin. The dynamic gain values can then be adjusted to reduce the residual noise captured by the error microphones, effectively canceling the noise sources.

At operation 506, the signal processing unit identifies relevant gain lookup table(s) based on the type of the noise reference signal. The inventors herein recognize that different noise sources may require distinct gain adjustment strategies, necessitating the use of separate lookup tables. For instance, the gain adjustment for an AVAS speaker reference signal may be based on vehicle speed, while the gain adjustment for a seat motor reference signal may be based on seat position. In one embodiment, the identification of the relevant gain lookup table(s) is performed by mapping the noise reference signal type to a corresponding lookup table index or identifier. This mapping may be stored in a configuration file or a data structure within the ANC system's memory, allowing for easy lookup and retrieval of the appropriate gain table(s).

At operation 508, the signal processing unit retrieves dynamic gain value(s) from the identified gain lookup table(s) using the estimated vehicle operating parameters as inputs. This operation involves indexing into the relevant lookup table(s) with the current values of the vehicle operating parameters and retrieving the corresponding dynamic gain value(s). In one embodiment, the lookup table(s) may be implemented as multi-dimensional arrays or data structures, where the vehicle operating parameters serve as indices or keys for accessing the stored dynamic gain values. For example, if the gain adjustment for an AVAS reference signal is based on vehicle speed, the lookup table may be a one-dimensional array indexed by the current vehicle speed value. If the gain adjustment for a seat motor reference signal depends on both seat position and motor status, the lookup table may be a two-dimensional array indexed by the seat position and motor status values. Alternatively, the lookup table(s) may be implemented using more complex data structures or algorithms, such as decision trees or neural networks, which can model non-linear relationships between the vehicle operating parameters and the dynamic gain values. This approach may be particularly useful when the gain adjustment strategy involves multiple interrelated parameters or when the relationships between the parameters and the desired gain values are complex or non-intuitive.

At operation 510, the signal processing unit outputs the retrieved dynamic gain value(s) for the noise reference signal. These dynamic gain values may be subsequently applied to the corresponding noise reference signal(s) in subsequent operations of method 400 (FIG. 4) to generate gain-adjusted noise reference signals. In one embodiment, the dynamic gain values are directly multiplied with the respective noise reference signals to produce the gain-adjusted noise reference signals. This operation may be performed by dedicated signal processing hardware or software modules within the ANC system's signal processing unit. In another embodiment, the dynamic gain values may undergo additional processing or conditioning before being applied to the noise reference signals. For example, the dynamic gain values may be smoothed or filtered to prevent abrupt changes in gain, which could introduce audible artifacts or instability in the noise cancellation process. Alternatively, the dynamic gain values may be scaled or normalized to ensure that the gain-adjusted noise reference signals remain within a desired range or to prevent saturation or clipping of the signals.

The method 500 for dynamically adjusting gain values based on vehicle operating parameters provides a flexible and adaptable approach to noise cancellation in automotive environments. By leveraging gain lookup tables and adjusting the gains of noise reference signals in real-time, the ANC system can effectively cancel a wide range of noise sources, including transient or non-stationary sources that may appear or disappear under certain vehicle conditions.

Referring to FIG. 6, a flowchart of a method 600 for mixing noise reference signals to produce a reduced set of noise reference signals is shown. In one example, the method 600 may be employed at operation 412 of method 400 (FIG. 4) by the signal processing unit 110 of the ANC system 100. The method 600 provides a technique for combining a plurality of gain-adjusted noise reference signals into a reduced set of combined reference signals, enabling the ANC system to cancel a wider variety of noise sources while operating within the computational constraints of embedded automotive processors.

At operation 602, the signal processing unit receives a plurality of gain-adjusted reference signals. These gain-adjusted reference signals are obtained by applying dynamic gain values to the original noise reference signals acquired from various sources, such as accelerometers, microphones, and other sensors within the vehicle cabin. The dynamic gain values are retrieved from gain lookup tables based on estimated vehicle operating parameters, as described in method 500 (FIG. 5). By adjusting the gains of the noise reference signals, the ANC system can adapt to changing noise conditions and vehicle operating states, improving noise cancellation performance. In one embodiment, the plurality of gain-adjusted reference signals includes signals from traditional accelerometers mounted on the vehicle chassis, as well as additional signals from noise sources like AVAS speakers, LiDAR sensors, seat motors, and HVAC blower motors. These additional noise sources are becoming increasingly relevant in modern vehicles, and the ability to incorporate their corresponding reference signals into the ANC system enhances its noise cancellation capabilities.

At operation 604, the signal processing unit initializes mixer parameters for the reference signal mixer. These parameters include the number of output combined reference signals to be generated and the gain values (or mixing gains) to be applied to each input gain-adjusted reference signal. The number of output combined reference signals is typically chosen to balance noise cancellation performance and computational complexity, as a larger number of combined reference signals generally improves performance but increases computational requirements. In one embodiment, the signal processing unit determines the number of output combined reference signals based on the available computational resources and the specific noise sources present in the vehicle cabin. For example, if the primary noise sources are road noise and AVAS speaker noise, the signal processing unit may generate two combined reference signals, one focused on road noise and the other on AVAS speaker noise.

Alternatively, the reference signal mixer may combine alternative noise source reference signals with accelerometer reference signals to produce a combined reference signal for the adaptive weight filter. In one example, the reference signal mixer receives the AVAS speaker reference signal, such as from a nearby microphone or the speaker input itself, and the reference signals from front accelerometers detecting road noise/vibrations at the front suspension. A higher mixing gain (e.g. 0 dB) is applied to the AVAS speaker signal as the target noise source, while a lower gain (e.g. −6 dB) is applied to the front accelerometer signals. These gain-adjusted signals are then summed to produce the combined reference signal for the adaptive weight filter, allowing effective AVAS noise cancellation while benefiting from the accelerometer road noise information.

In another embodiment, the reference signal mixer combines the seat motor signal with rear accelerometer signals to address noise generated by the seat motor during driver's seat position adjustment. The seat motor signal is acquired from a current sensor or tachometer, while the rear accelerometer signals capture road noise and vibrations at the rear suspension. A higher mixing gain, e.g., 0 dB, is applied to the seat motor signal as the target noise source, while a lower mixing gain, such as −3 dB, is applied to the rear accelerometer signals. These mixing gain-adjusted signals are summed to produce the combined reference signal for the adaptive weight filter, enabling effective seat motor noise cancellation in conjunction with road noise information from the accelerometers. The specific gain values can be tuned based on factors such as the proximity of the noise source to the accelerometers, the relative intensity and importance of each noise source, and the desired emphasis on certain noise sources within the combined reference signal.

At operation 606, the signal processing unit generates each output combined reference signal by summing the gain-adjusted reference signals using their corresponding mixer gain values. This operation is performed for each output combined reference signal in the reduced set. In one embodiment, the signal processing unit employs a weighted summation technique, where each gain-adjusted reference signal is multiplied by its respective mixing gain before being summed together to form the combined reference signal. For example, consider a scenario where the ANC system aims to cancel road noise and AVAS speaker noise. The signal processing unit may generate two combined reference signals: one for road noise cancellation and another for AVAS speaker noise cancellation. The combined reference signal for road noise cancellation could be formed by summing gain-adjusted reference signals from front and rear accelerometers, with higher mixing gains applied to the front accelerometer signals due to their proximity to the dominant road noise source. The combined reference signal for AVAS speaker noise cancellation could be formed by summing a gain-adjusted reference signal from an AVAS speaker microphone with lower mixing gains applied to the accelerometer signals, as they may capture some AVAS speaker noise but are less correlated with it.

At operation 608, the signal processing unit 110 outputs the reduced set of combined reference signals, e.g., to the adaptive filter update module 124. The adaptive filter update module 124 may employ the combined reference signals to adjust the filter coefficients of the adaptive weight filter, enabling the ANC system to generate an effective anti-noise signal for canceling the various noise sources within the vehicle cabin.

By employing the method 600, an ANC system may effectively incorporate a wide range of noise reference signals, including those from non-traditional sources like AVAS speakers, LiDAR sensors, seat motors, and HVAC blowers, without significantly increasing the computational complexity of the adaptive filtering process. The dynamic gain adjustment and reference signal mixing techniques allow the ANC system to adapt to changing noise conditions and vehicle operating states, while operating within the computational constraints of embedded automotive processors.

Referring to FIG. 7, a lookup table 700 for adjusting the gain of an AVAS noise reference signal based on different vehicle speeds is shown. The lookup table 700 is configured to dynamically control the gain of the AVAS noise reference signal in the ANC system, ensuring that the system effectively cancels the AVAS noise when it is active and avoids generating undesirable artifacts when the AVAS is deactivated.

The x-axis of the lookup table 700 represents the vehicle speed 702, which is used for inferring the operational state (or likely future operational state) of the AVAS. In one embodiment, the vehicle speed 702 is obtained from the vehicle's speed sensor or calculated based on data from the vehicle's CAN bus. The lookup table 700 includes two threshold speeds: a first threshold speed of 28 km/h and a second threshold speed of 30 km/h.

The first threshold speed, set at 28 km/h in this example, represents the speed at which the ANC system begins ramping down the gain of the AVAS reference signal. This preemptive gain reduction is implemented to prevent abrupt changes in the noise cancellation signal when the AVAS deactivates, which could result in undesirable noise artifacts or boosting effects. By gradually reducing the AVAS reference signal gain as the vehicle approaches the AVAS deactivation speed, the ANC system can smoothly transition to a state where the AVAS noise is no longer present, minimizing the risk of audible artifacts.

The second threshold speed, set at 30 km/h in this example, corresponds to the speed at which the AVAS is required to deactivate according to regulatory standards or vehicle manufacturer specifications. Above this speed, the AVAS speaker is turned off, and the ANC system should no longer attempt to cancel the AVAS noise, as it is no longer present in the vehicle cabin.

The y-axis of the lookup table 700 represents the AVAS reference signal gain 704, which is the gain applied to the AVAS reference signal before it is combined with other reference signals and provided to the adaptive weight filter of the ANC system. The lookup table 700 includes two distinct gain values: the first AVAS gain 706 and the second AVAS gain 710.

The first AVAS gain 706 represents the gain applied to the AVAS reference signal when the AVAS is active and the vehicle speed is below the first threshold speed of 28 km/h. In one embodiment, the first AVAS gain 706 is set to a value that ensures the AVAS reference signal contributes significantly to the combined reference signal, allowing the ANC system to effectively cancel the AVAS noise within the vehicle cabin.

As the vehicle speed increases and approaches the first threshold speed of 28 km/h, the lookup table 700 initiates the AVAS gain ramp down 708. This ramp down region 708 defines a gradual decrease in the AVAS reference signal gain 704 as the vehicle speed increases from 28 km/h to the second threshold speed of 30 km/h. The rate of gain reduction within the ramp down region 708 can be linear or follow a non-linear function, depending on the desired behavior and tuning requirements of the ANC system. In one embodiment, the AVAS gain ramp down 708 follows a linear function, where the AVAS reference signal gain 704 decreases linearly from the first AVAS gain 706 at 28 km/h to the second AVAS gain 710 at 30 km/h. This linear ramp down ensures a smooth transition and minimizes the risk of abrupt changes in the noise cancellation signal as the AVAS deactivates. In an alternative embodiment, the AVAS gain ramp down 708 may follow a non-linear function, such as an exponential or logarithmic decay, to achieve a more aggressive or gradual gain reduction depending on the specific requirements of the ANC system and the acoustic characteristics of the vehicle cabin.

Once the vehicle speed exceeds the second threshold speed of 30 km/h, the lookup table 700 applies the second AVAS gain 710 to the AVAS reference signal. The second AVAS gain 710 is typically set to a very low value or zero, effectively muting or significantly attenuating the AVAS reference signal contribution to the combined reference signal. This ensures that the A N C system does not attempt to cancel a noise source that is no longer present, preventing the generation of undesirable noise artifacts or boosting effects.

The lookup table 700 provides a flexible and configurable approach to adjusting the AVAS reference signal gain based on vehicle speed. The specific values of the first AVAS gain 706, the second AVAS gain 710, and the shape of the AVAS gain ramp down 708 can be tuned and calibrated through road testing and optimization processes to achieve the desired noise cancellation performance and minimize audible artifacts within the vehicle cabin.

Overall, the lookup table 700 enables the ANC system to dynamically adapt to the operational state of the AVAS, ensuring effective noise cancellation when the AVAS is active and preventing undesirable artifacts when the AVAS is deactivated. This dynamic gain adjustment approach enhances the overall acoustic experience for vehicle occupants and demonstrates the flexibility and adaptability of the disclosed ANC system in addressing the challenges posed by transient noise sources in automotive environments.

Referring to FIG. 8, an example lookup table 800 for adjusting a noise reference signal gain associated with a seat motor in a vehicle, is shown. The lookup table 800 is designed to dynamically adjust the gain of a seat motor reference signal used in an ANC system based on the position of the vehicle's seat. This dynamic gain adjustment allows the ANC system to effectively cancel noise generated by the seat motor while minimizing computational overhead and preventing noise boosting artifacts.

The lookup table 800 has two axes: the seat position 802 on the x-axis and the seat motor reference signal gain 804 on the y-axis. The seat position 802 represents the current position of the vehicle's seat, which can range from fully back to fully forward. This position can be determined using a seat position sensor or other suitable means of detecting the seat's location within the vehicle cabin.

The seat motor reference signal gain 804 represents the gain value applied to the reference signal obtained from the seat motor. This reference signal is used by the ANC system's adaptive filter to generate an anti-noise signal that cancels the noise produced by the seat motor. By adjusting the gain of this reference signal based on the seat position, the ANC system can optimize its noise cancellation performance and prevent undesirable artifacts.

In one embodiment, the lookup table 800 includes a first gain 806, which represents the gain applied to the seat motor reference signal when the seat is not moving, such as when it is in the fully back or fully forward position. This first gain 806 may be a predetermined value that is set during the calibration or tuning process of the ANC system. For example, the first gain 806 could be set to a low value, such as −20 dB, to minimize the contribution of the seat motor reference signal when the seat is stationary and the noise generated by the seat motor is minimal.

When the seat motor is actively moving, the lookup table 800 applies a second gain 810 to the seat motor reference signal. This second gain 810 is typically higher than the first gain 806 to account for the increased noise generated by the seat motor during movement. In one embodiment, the second gain 810 could be set to a value of 0 dB, effectively passing the seat motor reference signal through without attenuation or amplification.

In a first transition region starting at the fully back position and extending a pre-determined distance forward, the lookup table 800 employs a seat motor reference signal gain ramp up 808. This ramp up 808 gradually increases the gain applied to the seat motor reference signal as the seat moves forward (or conversely ramps down the seat motor reference signal gain as the seat moves backward through this first transition region), allowing the ANC system to smoothly adapt to the changing noise conditions. In one embodiment, the ramp up 808 could follow a linear function, gradually increasing the gain from the first gain 806 to the second gain 810 as the seat position changes. Alternatively, the ramp up 808 could follow a non-linear function, such as an exponential or logarithmic curve, to better match the noise characteristics of the seat motor during movement.

Conversely, in a second transition region, starting a pre-determined distance behind the fully forward position, and ending at the fully forward position, the lookup table 800 employs a seat motor reference signal gain ramp down 812 (or conversely, a ramp up if the seat moves backwards in this second transition region). This ramp down 812 gradually decreases the gain applied to the seat motor reference signal as the seat moves toward the fully forward position, allowing the ANC system to smoothly adapt to the changing noise conditions. In one embodiment, the ramp down 812 could mirror the ramp up 808, following a linear or non-linear function to gradually decrease the gain from the second gain 810 to the first gain 806 as the seat approaches the fully forward position.

The specific values and functions used for the first gain 806, second gain 810, ramp up 808, and ramp down 812 can be tuned and optimized based on road testing data and feedback from the ANC system's performance. Additionally, the lookup table 800 can be updated or recalibrated as needed to account for changes in the vehicle's acoustic environment or the introduction of new noise sources.

By employing the lookup table 800 for dynamic gain adjustment of the seat motor reference signal, the ANC system can effectively cancel noise generated by the seat motor while minimizing computational overhead and preventing noise boosting artifacts.

Referring to FIG. 9, a lookup table 900 for adjusting the gain of an HVAC blower noise reference sensor signal based on the HVAC blower speed is shown.

The HVAC blower speed 902 is shown along the x-axis of the lookup table 900. This parameter corresponds to the operational speed of the HVA C blower motor within the vehicle's HVAC system. The HVAC blower speed 902 can be obtained from various vehicle system sensors, such as a tachometer coupled to the HVAC blower motor or a sensor monitoring the HVAC system's control signals.

The HVAC blower reference signal gain 904 is shown along the y-axis of the lookup table 900. This parameter determines the dynamic gain value applied to the reference signal acquired from a sensor monitoring the noise generated by the HVAC blower motor. By adjusting the gain of this reference signal based on the HVAC blower speed 902, the ANC system can effectively cancel the noise produced by the HVAC blower while optimizing computational resources. In one embodiment, the lookup table 900 includes a first gain 906, which represents the gain value applied to the HVAC blower noise reference signal when the HVAC blower speed 902 is zero or below a predetermined threshold. This first gain 906 may be set to a low value or even zero, as the HVAC blower is not generating significant noise at low speeds or when it is turned off.

As the HVAC blower speed 902 increases, the lookup table 900 includes an HVAC blower reference signal gain ramp 908. This ramp 908 represents a gradual increase in the gain applied to the HVAC blower noise reference signal as the blower speed increases. The ramp 908 allows for a smooth transition in the gain adjustment, preventing abrupt changes that could potentially introduce artifacts or instability in the ANC system's performance. In one embodiment, the HVAC blower reference signal gain ramp 908 may follow a linear function, where the gain increases linearly with the HVAC blower speed 902. Alternatively, the ramp 908 may follow a non-linear function, such as an exponential or logarithmic curve, to better match the acoustic characteristics of the HVAC blower noise as the speed increases.

At the maximum HVAC blower speed, the lookup table 900 includes a second gain 910. This second gain 910 represents the maximum gain value applied to the HVAC blower noise reference signal when the blower is operating at its highest speed. The second gain 910 is typically set to a higher value than the first gain 906, as the HVAC blower noise is expected to be more prominent and require a stronger reference signal for effective cancellation. In one embodiment, the second gain 910 may be determined through empirical testing and calibration, where the ANC system's performance is evaluated at various HVAC blower speeds, and the second gain 910 is adjusted to achieve optimal noise cancellation at the maximum blower speed.

In an alternative embodiment, the lookup table 900 may include additional dimensions or parameters beyond the HVAC blower speed 902. For example, the lookup table 900 could incorporate factors such as vehicle speed, cabin temperature, or the position of the HVAC vents, which may influence the propagation and perception of HVAC blower noise within the vehicle cabin. By considering these additional parameters, the dynamic gain adjustment can be further refined, leading to even more precise and effective noise cancellation.

The lookup table 900 enables the dynamic gain module to retrieve the appropriate gain value for the HVAC blower noise reference signal based on the current HVAC blower speed 902. This dynamic gain adjustment ensures that the ANC system can effectively cancel the HVAC blower noise without allocating excessive computational resources when the noise is less prominent or absent. Furthermore, the lookup table 900 can be updated or recalibrated based on road testing data or feedback from the error microphones within the vehicle cabin. This recalibration process allows the ANC system to adapt to changes in the acoustic environment or variations in the HVAC system's noise characteristics, ensuring optimal noise cancellation performance over the lifetime of the vehicle.

Referring to FIG. 10, a process 1000 for noise reference signal gain adjustment and mixing is shown. The process 1000 is designed to enhance the performance and adaptability of active noise cancellation systems in automotive applications by dynamically adjusting and combining reference signals based on various vehicle operating conditions.

The process 1000 begins with a plurality of reference signal sensors, including a first reference signal sensor 1002 and an N^{th} reference signal sensor 1004, where N is a positive integer greater than one. These reference signal sensors are responsible for acquiring noise reference signals that are correlated with the sources of noise present within the vehicle cabin. In one embodiment, the reference signal sensors may include accelerometers mounted on the vehicle chassis to detect road noise and vibrations. In another embodiment, the reference signal sensors may comprise microphones positioned near known noise sources, such as AVAS speakers, LiDAR sensors, seat motors, or HVAC blower motors. Additionally, the reference signal sensors may include current sensors coupled to noise-generating components like seat motors or HVAC blower motors, providing reference signals directly correlated with the noise generated by these components.

The noise reference signals acquired by the reference signal sensors 1002 through 1004 are then processed through fixed reference signal gains 1006. The fixed reference signal gains 1006 apply predetermined gain values to the noise reference signals to properly scale and balance the reference sensor signals before further processing. In one embodiment, the fixed reference signal gains 1006 may apply gain values that are determined during a calibration process, where the relative strengths of the reference signals are measured, and appropriate gain factors are calculated to equalize their contributions. This calibration process can be performed during the installation or setup of the ANC system within the vehicle cabin.

After the fixed reference signal gains 1006, the noise reference signals are processed through one or more dynamic reference signal gain blocks, including a first dynamic reference signal gain 1008 through to a J^{th} dynamic reference signal gain 1012, where J is a positive non-zero integer. These dynamic reference signal gains are responsible for applying variable gain values to the noise reference signals based on various vehicle operating conditions. In one embodiment, the dynamic reference signal gains 1008 and 1012 may utilize gain lookup tables, such as a first lookup table 1010 and a J^{th} lookup table 1014, respectively. These lookup tables store pre-calculated gain values that are indexed by various vehicle operating parameters, such as vehicle speed, seat position, motor status, or HVAC blower speed.

For example, the first lookup table 1010 may contain gain values for adjusting the gain of a reference signal from an AVAS speaker based on the vehicle's speed. As the vehicle accelerates beyond a certain speed threshold, the AVAS speaker may be required to turn off, and the corresponding gain value in the lookup table can be used to ramp down or mute the AVAS reference signal, preventing the ANC system from boosting anti-noise for a non-existent source. In another embodiment, the J^{th} lookup table 1014 may include gain values for adjusting the gain of a seat motor reference signal based on the seat position. The gain value could be increased or decreased depending on whether the seat is in a fully forward or backward position, as the seat motor noise may decrease as the seat approaches either a fully forward or fully back position.

The dynamic reference signal gains 1008 and 1012, in conjunction with the lookup tables 1010 and 1014, allow the ANC system to dynamically adjust the gain of various noise reference signals based on the specific operating conditions of the vehicle. This dynamic gain adjustment enables the ANC system to effectively cancel a wider range of noise sources while preventing noise boosting artifacts that may occur when transient noise sources abruptly turn on or off. The use of multiple dynamic gain blocks 1008 and 1012, each with its own associated lookup table 1010 and 1014, respectively, provides a more composable and efficient approach to determining the appropriate gain for each noise reference signal.

By employing separate dynamic gain blocks and lookup tables for different noise reference signals, the system can independently apply distinct gain adjustment factors based on the unique characteristics and operating conditions of each noise source. For example, the gain of an AVAS speaker reference signal may be primarily dependent on vehicle speed, while the gain of a seat motor reference signal could be influenced by factors such as seat position and motor status. Utilizing separate lookup tables allows the system to efficiently apply these different gain adjustment factors without the need for complex calculations or combinations of multiple factors within a single lookup table.

Furthermore, this modular approach enables the system to easily incorporate additional gain adjustment factors or noise sources in the future. If a new noise source is introduced, a dedicated dynamic gain block and lookup table can be added to the system, without requiring modifications to the existing gain adjustment mechanisms for other noise sources. This enhances the scalability and extensibility of the ANC system, allowing it to adapt to evolving vehicle designs and noise cancellation requirements.

Moreover, the use of multiple dynamic gain blocks and lookup tables facilitates efficient computation and memory utilization. Each lookup table can be optimized to store only the relevant gain values for its associated noise source, based on the specific operating parameters that influence that noise source. This targeted storage and retrieval of gain values can reduce memory requirements and improve computational efficiency compared to a single, monolithic lookup table that would need to accommodate all possible combinations of operating parameters and noise sources. By separating the gain adjustment process into modular components, the system can also leverage parallel processing capabilities, if available, to further enhance computational efficiency. Each dynamic gain block and its associated lookup table can be processed independently, allowing for concurrent gain adjustment calculations for multiple noise reference signals.

After the noise reference signal has passed through the first dynamic reference signal gains 1008 through to the J^{th} dynamic reference signal gains 1012, the gain-adjusted noise reference signals are fed into a reference signal mixer 1016. The reference signal mixer 1016 is responsible for combining or mixing the gain-adjusted noise reference signals into a reduced set of combined reference signals. In one embodiment, the reference signal mixer 1016 may apply a predetermined mixing strategy to combine the gain-adjusted noise reference signals. This mixing strategy may involve summing the reference signals with specific mixing gain values or applying a weighted combination based on factors such as the proximity of the reference signal sensors to the noise sources or the relative importance of each noise source.

For example, the reference signal mixer 1016 may combine a gain-adjusted reference signal from an accelerometer mounted near the front suspension with a gain-adjusted reference signal from an AVAS speaker located in the front of the vehicle. The mixing strategy could involve applying a higher mixing gain to the AVAS reference signal if the AVAS noise is more prominent or applying a lower mixing gain if the road noise from the front suspension is the dominant source. In another embodiment, the reference signal mixer 1016 may employ an adaptive mixing strategy, where the mixing gains or combinations are dynamically adjusted based on feedback from error microphones or other sensors within the vehicle cabin. This adaptive approach allows the ANC system to optimize the contribution of each reference signal to the combined reference signals, ensuring effective noise cancellation under varying noise conditions.

The output of the reference signal mixer 1016 is a reduced set of combined reference signals, including a first mixed and gain-adjusted reference sensor signal 1018 through to a Kth mixed and gain-adjusted reference sensor signal 1020, where K is a positive non-zero integer less than or equal to N. These combined reference signals represent a combination of the gain-adjusted noise reference signals from the various reference signal sensors, with the mixing strategy tailored to the specific noise environment and operating conditions of the vehicle.

The reduced set of combined reference signals 1018 and 1020 is then provided to the adaptive weight filter of the ANC system, allowing the filter coefficients to be adjusted based on these combined reference signals. This approach enables the ANC system to effectively cancel a wide variety of noise sources, including transient sources, without excessively increasing computational overhead or memory requirements. By dynamically adjusting the reference signal gains and mixing the reference signals, the process 1000 provides a flexible and computationally efficient solution for improving noise cancellation performance across an increasing variety of noise sources in modern vehicles.

The disclosure also provides support for a method for adjusting reference signals in an active noise cancellation (ANC) system, the method comprising: receiving a plurality of noise reference signals, wherein the plurality of noise reference signals comprises signals from one or more accelerometers and one or more additional noise sources, estimating one or more vehicle operating parameters, retrieving, from one or more lookup tables, dynamic gain values for each of the plurality of noise reference signals based on the estimated one or more vehicle operating parameters, applying the retrieved dynamic gain values to the plurality of noise reference signals to generate a plurality of gain-adjusted noise reference signals, combining the plurality of gain-adjusted noise reference signals to generate a reduced set of combined reference signals, and adjusting filter coefficients of the ANC system based on the reduced set of combined reference signals. In a first example of the method, combining the plurality of gain-adjusted noise reference signals comprises: applying a respective mixing gain to each of the plurality of gain-adjusted noise reference signals to produce a plurality of mixing gain-adjusted noise reference signals, and summing the plurality of mixing gain-adjusted noise reference signals to generate the reduced set of combined reference signals. In a second example of the method, optionally including the first example, the one or more additional noise sources comprise at least one of an acoustic vehicle alerting system (AVAS) speaker signal, a LIDAR sensor signal, a seat motor signal, or an HVAC blower signal. In a third example of the method, optionally including one or both of the first and second examples, retrieving the dynamic gain values comprises: identifying a lookup table corresponding to a respective noise reference signal based on a type of the noise reference signal, and retrieving a dynamic gain value from the identified lookup table using the estimated one or more vehicle operating parameters as inputs. In a fourth example of the method, optionally including one or more or each of the first through third examples, the one or more vehicle operating parameters comprise at least one of a vehicle speed, an engine RPM, a seat position, or an HVAC blower speed. In a fifth example of the method, optionally including one or more or each of the first through fourth examples, applying the retrieved dynamic gain values comprises ramping down or muting a dynamic gain value for a noise reference signal corresponding to a noise source responsive to an operating parameter of the noise source exceeding a threshold operating parameter. In a sixth example of the method, optionally including one or more or each of the first through fifth examples, the method further comprises: applying fixed gains to the plurality of noise reference signals prior to applying the dynamic gain values.

The disclosure also provides support for a noise cancellation system for a vehicle, comprising: a plurality of reference sensors configured to acquire a plurality of reference signals correlated to noise sources within a vehicle cabin, wherein the noise sources comprise at least one of an acoustic vehicle alerting system (AVAS) speaker, a light detection and ranging (LiDaR) sensor, a seat motor, and a heating, ventilation, and air conditioning (HVAC) blower motor, an adaptive weight filter in electronic communication with the plurality of reference sensors, configured to apply an adaptive filtering process to the plurality of reference signals to produce a noise cancellation signal, a plurality of speakers positioned within the vehicle cabin and in electronic communication with the adaptive weight filter, configured to emit the noise cancellation signal into the vehicle cabin, a plurality of error microphones positioned within the vehicle cabin and configured to record a residual signal resulting from interaction of the emitted noise cancellation signal and the noise sources within the vehicle cabin, and a signal processing unit in electronic communication with the plurality of reference sensors and the plurality of error microphones, wherein the signal processing unit comprises: a non-transitory memory storing a plurality of gain lookup tables and instructions, and a processor, wherein, when executing the instructions, the processor is configured to: estimate one or more vehicle operating parameters, retrieve, from the plurality of gain lookup tables, a plurality of dynamic gain values for the plurality of reference signals based on the estimated one or more vehicle operating parameters and a type of each reference signal, apply the plurality of dynamic gain values to the plurality of reference signals to produce a plurality of gain-adjusted reference signals, combine the plurality of gain-adjusted reference signals into a reduced set of combined reference signals using a reference signal mixer, and provide the reduced set of combined reference signals to the adaptive weight filter to adjust the noise cancellation signal based on the combined reference signals. In a first example of the system, the system further comprises: a plurality of vehicle system sensors configured to detect one or more vehicle operating parameters, wherein the one or more vehicle operating parameters comprise at least one of a vehicle speed, a seat position, a motor status, and a blower speed. In a second example of the system, optionally including the first example, the plurality of reference sensors comprise at least one of an accelerometer, a microphone positioned to detect sound from the AVAS speaker, a current sensor coupled to the seat motor, and a tachometer coupled to the HVAC blower motor. In a third example of the system, optionally including one or both of the first and second examples, the plurality of speakers are positioned at locations within the vehicle cabin corresponding to expected noise locations of the noise sources. In a fourth example of the system, optionally including one or more or each of the first through third examples, the signal processing unit further comprises a controller area network (CAN) bus interface configured to receive the one or more vehicle operating parameters from a vehicle network. In a fifth example of the system, optionally including one or more or each of the first through fourth examples, the adaptive weight filter comprises an filtered-x least mean squares (FxLMS) algorithm adapted to adjust filter coefficients based on the reduced set of combined reference signals and the residual signal from the plurality of error microphones.

The disclosure also provides support for a method for adjusting reference signals in an active noise cancellation (ANC) system for a vehicle, the method comprising: acquiring a first noise reference signal from an accelerometer and a second noise reference signal from an additional noise source within the vehicle, estimating one or more vehicle operating parameters based on data from one or more vehicle system sensors, retrieving, from a first gain lookup table, a first dynamic gain value for the first noise reference signal based on the estimated one or more vehicle operating parameters, retrieving, from a second gain lookup table, a second dynamic gain value for the second noise reference signal based on the estimated one or more vehicle operating parameters and a type of the additional noise source, applying the first dynamic gain value to the first noise reference signal and applying the second dynamic gain value to the second noise reference signal to generate a first gain-adjusted noise reference signal and a second gain-adjusted noise reference signal, respectively, applying a first mixing gain to the first gain-adjusted noise reference signal and a second mixing gain to the second gain-adjusted noise reference signal to produce a first mixing gain-adjusted noise reference signal and a second mixing gain-adjusted noise reference signal, summing the first mixing gain-adjusted noise reference signal and the second mixing gain-adjusted noise reference signal to generate a combined reference signal, providing the combined reference signal to an adaptive weight filter of the ANC system, and adjusting filter coefficients of the adaptive weight filter based on the combined reference signal and a residual signal from a plurality of error microphones within a cabin of the vehicle. In a first example of the method, the method further comprises: adjusting the first mixing gain and the second mixing gain based on a predetermined mixing strategy to control a contribution of the first gain-adjusted noise reference signal and the second gain-adjusted noise reference signal to the combined reference signal. In a second example of the method, optionally including the first example, the first gain lookup table and the second gain lookup table are configured to be updated based on road testing data to calibrate noise cancellation performance for different noise sources. In a third example of the method, optionally including one or both of the first and second examples, the method further comprises: acquiring a third noise reference signal from a third noise source within the vehicle, retrieving, from a third gain lookup table, a dynamic gain value for the third noise reference signal based on the estimated one or more vehicle operating parameters and a type of the third noise source, applying the retrieved dynamic gain value to the third noise reference signal to generate a third gain-adjusted noise reference signal, applying a third mixing gain to the third gain-adjusted noise reference signal to produce a third mixing gain-adjusted noise reference signal, and summing the third mixing gain-adjusted noise reference signal with the first mixing gain-adjusted noise reference signal and the second mixing gain-adjusted noise reference signal to generate the combined reference signal. In a fourth example of the method, optionally including one or more or each of the first through third examples, the first mixing gain and the second mixing gain are determined based on a proximity of the accelerometer to the additional noise source within the vehicle. In a fifth example of the method, optionally including one or more or each of the first through fourth examples, the method further comprises: determining a distance between the accelerometer and the additional noise source within the vehicle, in response to determining that the distance is less than a predetermined threshold distance, increasing the second mixing gain as the distance decreases, and in response to determining that the distance is greater than the predetermined threshold distance, setting the second mixing gain to zero. In a sixth example of the method, optionally including one or more or each of the first through fifth examples, increasing the second mixing gain as the distance decreases comprises applying a gain function that monotonically increases the second mixing gain as the distance decreases from the predetermined threshold distance to a minimum distance value.

Aspects of the present disclosure are described above with reference to flow chart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

While the foregoing is directed to embodiments of the present disclosure, other and further embodiments of the disclosure may be devised without departing from the basic scope thereof, and the scope thereof is determined by the claims that follow.

1. A method for adjusting reference signals in an active noise cancellation (ANC) system, the method comprising:
receiving a plurality of noise reference signals, wherein the plurality of noise reference signals comprises signals from one or more accelerometers and one or more additional noise sources;
estimating one or more vehicle operating parameters;
retrieving, from one or more lookup tables, dynamic gain values for each of the plurality of noise reference signals based on the estimated one or more vehicle operating parameters;
applying the retrieved dynamic gain values to the plurality of noise reference signals to generate a plurality of gain-adjusted noise reference signals;
combining the plurality of gain-adjusted noise reference signals to generate a reduced set of combined reference signals; and
adjusting filter coefficients of the ANC system based on the reduced set of combined reference signals.

2. The method of claim 1, wherein combining the plurality of gain-adjusted noise reference signals comprises:
applying a respective mixing gain to each of the plurality of gain-adjusted noise reference signals to produce a plurality of mixing gain-adjusted noise reference signals; and
summing the plurality of mixing gain-adjusted noise reference signals to generate the reduced set of combined reference signals.

3. The method of claim 1, wherein the one or more additional noise sources comprise at least one of an acoustic vehicle alerting system (AVAS) speaker signal, a LIDAR sensor signal, a seat motor signal, or an HVAC blower signal.

4. The method of claim 1, wherein retrieving the dynamic gain values comprises:
identifying a lookup table corresponding to a respective noise reference signal based on a type of the noise reference signal; and
retrieving a dynamic gain value from the identified lookup table using the estimated one or more vehicle operating parameters as inputs.

5. The method of claim 4, wherein the one or more vehicle operating parameters comprise at least one of a vehicle speed, an engine RPM, a seat position, or an HVAC blower speed.

6. The method of claim 1, wherein applying the retrieved dynamic gain values comprises ramping down or muting a dynamic gain value for a noise reference signal corresponding to a noise source responsive to an operating parameter of the noise source exceeding a threshold operating parameter.

7. The method of claim 1, further comprising:
applying fixed gains to the plurality of noise reference signals prior to applying the dynamic gain values.

8. A noise cancellation system for a vehicle, comprising:
a plurality of reference sensors configured to acquire a plurality of reference signals correlated to noise sources within a vehicle cabin, wherein the noise sources comprise at least one of an acoustic vehicle alerting system (AVAS) speaker, a light detection and ranging (LiDAR) sensor, a seat motor, and a heating, ventilation, and air conditioning (HVAC) blower motor;
an adaptive weight filter in electronic communication with the plurality of reference sensors, configured to apply an adaptive filtering process to the plurality of reference signals to produce a noise cancellation signal;
a plurality of speakers positioned within the vehicle cabin and in electronic communication with the adaptive weight filter, configured to emit the noise cancellation signal into the vehicle cabin;
a plurality of error microphones positioned within the vehicle cabin and configured to record a residual signal resulting from interaction of the emitted noise cancellation signal and the noise sources within the vehicle cabin; and
a signal processing unit in electronic communication with the plurality of reference sensors and the plurality of error microphones, wherein the signal processing unit comprises:
a non-transitory memory storing a plurality of gain lookup tables and instructions; and
a processor, wherein, when executing the instructions, the processor is configured to:
estimate one or more vehicle operating parameters;
retrieve, from the plurality of gain lookup tables, a plurality of dynamic gain values for the plurality of reference signals based on the estimated one or more vehicle operating parameters and a type of each reference signal;
apply the plurality of dynamic gain values to the plurality of reference signals to produce a plurality of gain-adjusted reference signals;
combine the plurality of gain-adjusted reference signals into a reduced set of combined reference signals using a reference signal mixer; and
provide the reduced set of combined reference signals to the adaptive weight filter to adjust the noise cancellation signal based on the combined reference signals.

9. The noise cancellation system of claim 8, further comprising a plurality of vehicle system sensors configured to detect one or more vehicle operating parameters, wherein the one or more vehicle operating parameters comprise at least one of a vehicle speed, a seat position, a motor status, and a blower speed.

10. The noise cancellation system of claim 8, wherein the plurality of reference sensors comprise at least one of an accelerometer, a microphone positioned to detect sound from the AVAS speaker, a current sensor coupled to the seat motor, and a tachometer coupled to the HVAC blower motor.

11. The noise cancellation system of claim 8, wherein the plurality of speakers are positioned at locations within the vehicle cabin corresponding to expected noise locations of the noise sources.

12. The noise cancellation system of claim 8, wherein the signal processing unit further comprises a controller area network (CAN) bus interface configured to receive the one or more vehicle operating parameters from a vehicle network.

13. The noise cancellation system of claim 8, wherein the adaptive weight filter comprises an filtered-x least mean squares (FxLMS) algorithm adapted to adjust filter coefficients based on the reduced set of combined reference signals and the residual signal from the plurality of error microphones.

14. A method for adjusting reference signals in an active noise cancellation (ANC) system for a vehicle, the method comprising:
acquiring a first noise reference signal from an accelerometer and a second noise reference signal from an additional noise source within the vehicle;
estimating one or more vehicle operating parameters based on data from one or more vehicle system sensors;
retrieving, from a first gain lookup table, a first dynamic gain value for the first noise reference signal based on the estimated one or more vehicle operating parameters;
retrieving, from a second gain lookup table, a second dynamic gain value for the second noise reference signal based on the estimated one or more vehicle operating parameters and a type of the additional noise source;
applying the first dynamic gain value to the first noise reference signal and applying the second dynamic gain value to the second noise reference signal to generate a first gain-adjusted noise reference signal and a second gain-adjusted noise reference signal, respectively;
applying a first mixing gain to the first gain-adjusted noise reference signal and a second mixing gain to the second gain-adjusted noise reference signal to produce a first mixing gain-adjusted noise reference signal and a second mixing gain-adjusted noise reference signal;
summing the first mixing gain-adjusted noise reference signal and the second mixing gain-adjusted noise reference signal to generate a combined reference signal;
providing the combined reference signal to an adaptive weight filter of the ANC system; and
adjusting filter coefficients of the adaptive weight filter based on the combined reference signal and a residual signal from a plurality of error microphones within a cabin of the vehicle.

15. The method of claim 14, further comprising:
adjusting the first mixing gain and the second mixing gain based on a predetermined mixing strategy to control a contribution of the first gain-adjusted noise reference signal and the second gain-adjusted noise reference signal to the combined reference signal.

16. The method of claim 14, wherein the first gain lookup table and the second gain lookup table are configured to be updated based on road testing data to calibrate noise cancellation performance for different noise sources.

17. The method of claim 14, further comprising:
acquiring a third noise reference signal from a third noise source within the vehicle;
retrieving, from a third gain lookup table, a dynamic gain value for the third noise reference signal based on the estimated one or more vehicle operating parameters and a type of the third noise source;
applying the retrieved dynamic gain value to the third noise reference signal to generate a third gain-adjusted noise reference signal;
applying a third mixing gain to the third gain-adjusted noise reference signal to produce a third mixing gain-adjusted noise reference signal; and
summing the third mixing gain-adjusted noise reference signal with the first mixing gain-adjusted noise reference signal and the second mixing gain-adjusted noise reference signal to generate the combined reference signal.

18. The method of claim 14, wherein the first mixing gain and the second mixing gain are determined based on a proximity of the accelerometer to the additional noise source within the vehicle.

19. The method of claim 14, further comprising:
determining a distance between the accelerometer and the additional noise source within the vehicle;
in response to determining that the distance is less than a predetermined threshold distance, increasing the second mixing gain as the distance decreases; and
in response to determining that the distance is greater than the predetermined threshold distance, setting the second mixing gain to zero.

20. The method of claim 19, wherein increasing the second mixing gain as the distance decreases comprises applying a gain function that monotonically increases the second mixing gain as the distance decreases from the predetermined threshold distance to a minimum distance value.
